(19) United States
(12) Patent Application Publication
(10) Pub. No.: US 2023/0356357 A1
(43) Pub. Date: Nov. 9, 2023

(54) CLEANING APPLIANCE

(71) Applicant: Alfred Kärcher SE & Co. KG, Winnenden (DE)

(72) Inventor: Lars Eckstein, Winnenden (DE)

(21) Appl. No.: 18/315,421

(22) Filed: May 10, 2023

Related U.S. Application Data
(63) Continuation of application No. PCT/EP2021/081332, filed on Nov. 11, 2021.

(30) Foreign Application Priority Data
Nov. 11, 2020 (DE) 10 2020 129 724.6

(51) Int. Cl. B24C 1/00; B24C 7/00

(52) U.S. Cl. CPC B24C 1/003; B24C 7/0092

(57) ABSTRACT

The invention relates to a cleaning appliance for blasting surfaces to be treated with a mixed stream of a pressurized gas and CO₂ pellets, said cleaning appliance comprising an apparatus for producing CO₂ pellets from liquid or gaseous CO₂, wherein the apparatus comprises a pre-compression device for compressing CO₂ snow to form the CO₂ pellets, wherein the cleaning appliance comprises a drive device with a drive shaft for driving the compressing device, and wherein the drive shaft, during the intended use of the cleaning appliance, extends in parallel or substantially in parallel to the direction of gravity.

### CROSS-REFERENCE TO RELATED APPLICATIONS

This application is a continuation of international application number PCT/EP2021/081332, filed on Nov. 11, 2021, and claims the benefit of German application number 10 2020 129 724.6, filed on Nov. 11, 2020, which are incorporated herein by reference in their entirety and for all purposes.

### FIELD OF THE INVENTION

The present invention relates to cleaning appliances generally, and more specifically to a cleaning appliance for blasting surfaces to be treated with a mixed stream of a pressurized gas and CO₂ pellets, comprising an apparatus for producing CO₂ pellets from liquid or gaseous CO₂.

### BACKGROUND OF THE INVENTION

A cleaning appliance of the kind described at the outset is known, e.g., from DE 10 2013 113 275 A1. The known cleaning appliance makes it possible to not only act upon surfaces to be treated with a mixed stream of a pressurized gas, for example pressurized air, and CO₂ pellets, but also to produce the CO₂ pellets directly from liquid or gaseous CO₂. This has the great advantage that CO₂ pellets are always available when the cleaning appliance is to be used, without any storage expenditure.

However, cleaning appliances of that kind are relatively large and difficult to handle. Furthermore, blasting cleaning systems and methods for blasting surfaces to be cleaned with a pressurized gas stream containing water ice particles are described in US 2019/0255675 A1.

### SUMMARY OF THE INVENTION

In an aspect of the invention, a cleaning appliance for blasting surfaces to be treated with a mixed stream of a pressurized gas and CO₂ pellets is provided. The cleaning appliance comprises an apparatus for producing CO₂ pellets from liquid or gaseous CO₂. The apparatus comprises a compressing device for compressing CO₂ snow to form the CO₂ pellets. The cleaning appliance comprises a drive device with a drive shaft for driving the compressing device. During the intended use of the cleaning appliance, the drive shaft extends in parallel or substantially in parallel to the direction of gravity.

### BRIEF DESCRIPTION OF THE DRAWING FIGURES

The foregoing summary and the following description may be better understood in conjunction with the drawing figures, of which:

FIG. 1: shows a perspective total view of a first embodiment of a cleaning appliance;

FIG. 2: shows a further perspective view the cleaning appliance from FIG. 1;

FIG. 3: shows a further perspective view the cleaning appliance from FIG. 1;

FIG. 4: shows a further perspective view the cleaning appliance from FIG. 1;

FIG. 5: shows a view of the cleaning appliance from FIG. 1 from the front;

FIG. 6: shows a view of the cleaning appliance from FIG. 5 in the direction of the arrow A;

FIG. 7: shows a view of the cleaning appliance from FIG. 5 in the direction of the arrow B;

FIG. 8: shows a view of the cleaning appliance from FIG. 5 in the direction of the arrow C;

FIG. 9: shows a view of the cleaning appliance from FIG. 5 in the direction of the arrow D;

FIG. 10: shows a partially cut perspective view depiction of the cleaning appliance from FIG. 1;

FIG. 11: shows a further schematic perspective, partially cut view of the cleaning appliance from FIG. 1;

FIG. 12: shows a view of the cleaning appliance from FIG. 5 from above, similar to FIG. 8, with the housing partially removed;

FIG. 13: shows a view of the cleaning appliance from FIG. 5 from above with the housing completely removed;

FIG. 14: shows a perspective total view of the arrangement from FIG. 13;

FIG. 15: shows a partial view of the arrangement from FIG. 14 with the input device removed;

FIG. 16: shows an enlarged partial view of the arrangement from FIG. 15;

FIG. 17: shows a perspective view of the cleaning appliance from FIG. 14 without the housing;

FIG. 18: shows a perspective, partially broken total view of a further embodiment of a cleaning appliance;

FIG. 19: shows a partially broken view of the cleaning appliance from FIG. 18 from the front;

FIG. 20: shows a schematic perspective total view the cleaning appliance from FIG. 18 with the housing removed and the input device removed;

FIG. 21: shows a further perspective view of the arrangement from FIG. 20;

FIG. 22: shows a further perspective view of the arrangement from FIG. 21 with the CO₂ store removed from the cleaning appliance; and

FIG. 23: shows partially cut side view of the arrangement from FIG. 18.

### DETAILED DESCRIPTION OF THE INVENTION

Although the invention is illustrated and described herein with reference to specific embodiments, the invention is not intended to be limited to the details shown. Rather, various modifications may be made in the details within the scope and range of equivalents of the claims and without departing from the invention.

The invention relates to a cleaning appliance for blasting surfaces to be treated with a mixed stream of a pressurized gas and CO₂ pellets, comprising an apparatus for producing CO₂ pellets from liquid or gaseous CO₂, wherein the apparatus comprises a compressing device for compressing CO₂ snow to form the CO₂ pellets, wherein the cleaning appliance comprises a drive device with a drive shaft for driving the compressing device, and wherein, during the intended use of the cleaning appliance, the drive shaft extends in parallel or substantially in parallel to the direction of gravity.

The further development proposed in accordance with the invention enables, in particular, a compact structure of the cleaning appliance. In particular, the orientation of the drive device, i.e., in particular, the proposed vertical installation thereof, makes it possible to configure the cleaning appliance having a smallest possible footprint. It thus has a small space requirement, which is advantageous when the cleaning appliance is not in use and must be stored. Furthermore, it can thus also be used in relatively small workshops. Moreover, due to the particular arrangement of the drive device, a center of gravity of the cleaning appliance can be predetermined in a defined manner. By means of the compressing device, in particular, defined CO₂ pellets can advantageously be formed. It is configured, in particular, to further compress CO₂ snow to form CO₂ pellets.

The cleaning appliance can be formed in a simple and cost-effective manner if the drive device comprises an electric motor. An electric motor makes it possible, in particular, to form a cleaning appliance having a high reliability and a long service life.

In order to be able to exert compressing forces that are as high as possible for compressing CO₂ snow, it is favorable if the cleaning appliance comprises a transmission coupled to the drive device and if the transmission is coupled to the compressing device in a driving manner. The transmission can be configured, in particular, to redirect a drive direction. For example, a transmission shaft in the form of a drive shaft, which is coupled to the compressing device in a driving manner, may extend, in particular rotate, transversely to the drive shaft and, in particular, transversely, preferably perpendicularly, to the direction of gravity. In particular, the drive shaft and the transmission shaft may be oriented askew to one another, i.e. not intersecting one another, for driving the compressing device. In particular, a compact structure of the cleaning appliance can be achieved in this way. In particular, for example, two meshing gears of a gear compressor, which is comprised by the compressing device, can thus be directly driven with the described orientation of the transmission shaft. Then, no further redirection of force in a different direction is necessary.

In accordance with a further preferred embodiment of the invention, provision may be made, in particular in the case of a cleaning appliance of the kind described at the outset, that the cleaning appliance defines a main plane, that the main plane extends in parallel to the direction of gravity and extends from a rear side to a front side of the cleaning appliance, wherein the main plane defines a symmetry plane or substantially defines a symmetry plane of the cleaning appliance. Thus, in particular, a compact cleaning appliance that is simple to use for a user can be formed. A symmetrical or substantially symmetrical structure of the cleaning appliance can also improve its stability. A risk of the cleaning appliance tipping over can thus be significantly reduced.

In particular, in order to improve a stability of the cleaning appliance, it is advantageous if the drive shaft extends in the main plane. In particular, the drive device as a whole may be arranged in the main plane, i.e. symmetrically thereto. In particular when the cleaning appliance is of mobile configuration, a risk of the cleaning appliance being able to tip over can be reduced.

The compressing device preferably comprises a pre-compression device and a main compressing device. This further development is also advantageous, in particular, in the case of a cleaning appliance of the kind described at the outset. The proposed further development makes it possible, in particular, to form CO₂ pellets in an at least two-step process. For example, liquid CO₂ or pressurized CO₂ gas can be converted to CO₂ snow and pre-compressed with the pre-compression device. By means of the main compressing device, in particular, CO₂ snow, for example already pre-compressed CO₂ snow, can then be formed to CO₂ pellets, for example by compression in a gear compressor or upon pressing through a die.

It is favorable if the pre-compression device is configured to pre-compress CO₂ snow produced by expanding liquid or pressurized CO₂. The pre-compression of CO₂ snow makes it possible, in particular, to form high-strength CO₂ pellets in a subsequent compression process. Here, it is advantageous, in particular, if the pre-compression device is configured in the form of a fluid-mechanical pre-compression device. This has the advantage, in particular, that no moving parts are required. Thus, for example, the energy required for pre-compression can be drawn from the liquid or pressurized CO₂. This enables a cost-effective production and a simple construction of the cleaning appliance and also reduces maintenance expenditure.

It is advantageous if the fluid mechanical pre-compression device comprises a pre-compression chamber and is configured to generate a gaseous CO₂ stream in the pre-compression chamber, said stream being oriented at least partially at an inner wall face of the pre-compression chamber. The gaseous CO₂ stream striking the inner wall face of the pre-compression chamber can thus collect on the inner wall face CO₂ snow that forms upon expansion of the CO₂ stream and compress it in this way. The gaseous CO₂ stream can further serve to detach agglomerated CO₂ snow from the inner wall face and to further convey it, for example to the main compressing device.

It is advantageous if the pre-compression chamber comprises a pre-compression chamber inlet and a pre-compression chamber outlet. Thus, for example, gaseous or liquid CO₂ can be conducted through the pre-compression chamber inlet into the pre-compression chamber in order to form CO₂ snow in said chamber and to pre-compress the CO₂ snow. CO₂ snow, in particular pre-compressed CO₂ snow, can be delivered through the pre-compression chamber outlet to the main compressing device. In particular, it is favorable if the pre-compression chamber is of curved configuration between the pre-compression chamber inlet and the pre-compression chamber outlet. This configuration has the advantage, in particular, that a probability is increased that gaseous CO₂ strikes an inner wall face of the pre-compression chamber in order to thus form CO₂ snow, which is able to collect on the inner wall face and also thereby be compressed. Furthermore, the curved pre-compression chamber can also utilize gravitational force in order to, for example, convey formed CO₂ snow to the pre-compression chamber outlet and thus to the main compressing device solely by means of the gaseous CO₂ stream, without additional aids.

A compact configuration of the cleaning appliance can be achieved, in particular, by the pre-compression chamber inlet defining an inlet longitudinal axis, which extends transversely, in particular perpendicularly, to the direction of gravity. Inflowing gas can thus particularly easily strike an inner wall face of the pre-compression chamber due to the acting gravitational force.

It is favorable if the pre-compression chamber outlet defines an outlet longitudinal axis, which extends in parallel or substantially in parallel to the direction of gravity. This makes it possible, in particular, to utilize the gravitational force in order to convey CO₂ snow from the pre-compression chamber, for example toward a main compressing device.

The pre-compression chamber outlet is advantageously arranged or formed above the main compressing device relative to the direction of gravity. This makes it possible, in particular, to convey CO₂ snow, in particular pre-compressed CO₂ snow, directly into the main compressing device with the assistance of gravity.

A particularly compact structure of the cleaning appliance can be achieved, in particular, by the pre-compressing device extending in parallel or substantially in parallel to the main plane. In particular, it can thus be made possible to make the entire process for producing the CO₂ pellets have minimal directional changes for the flowing CO₂ gas and the formed CO₂ pellets.

The cleaning appliance, in particular a cleaning appliance of the kind described at the outset, preferably comprises a CO₂ store. This configuration makes it possible, in particular, to use CO₂, liquid or gaseous, stored in the CO₂ store for producing CO₂ pellets. A storage of CO₂ pellets is complex and requires extensive cooling. CO₂ in liquid or gaseous form can be stored in a simple manner, for example in bottles of different sizes.

To form CO₂ pellets, in particular from CO₂ snow, it is advantageous, in particular, if the CO₂ store contains liquid CO₂ or pressurized gaseous CO₂. CO₂ is already liquid at a pressure of about 5.2 bar.

The cleaning appliance can be handled in a simple manner if the CO₂ store is configured in the form of a CO₂ bottle, if the CO₂ bottle defines a bottle longitudinal axis, and if the bottle longitudinal axis is oriented in parallel or substantially in parallel to the direction of gravity. Such a CO₂ bottle may be configured, in particular, as a pressurized container with a substantially cylindrical form. Furthermore, the stability of the cleaning appliance can be improved if the bottle longitudinal axis extends in the main plane or near the main plane.

A particularly high stability of the cleaning appliance can be achieved, in particular, by the CO₂ store being arranged symmetrically relative to the main plane. Thus, in particular, when using very large and heavy CO₂ bottles, a risk of the cleaning appliance tipping over can be reduced.

The CO₂ store is preferably fluidically connected to the compressing device, in particular to the pre-compression device. Thus, the cleaning appliance can be configured in a particularly compact manner. Liquid or gaseous CO₂ can be conducted directly from the CO₂ store into the compressing device, in particular into the pre-compression device.

The handling of the cleaning appliance can be further improved, in particular, by the cleaning appliance comprising a store holding device for the CO₂ store. The CO₂ store can thus be spatially positioned relative to the compressing device, in particular in a defined manner. In addition, the CO₂ store can be exchanged as needed, in particular when it is empty.

A CO₂ store can be positioned in a defined manner if the store holding device defines a store receptacle for the CO₂ store. For example, the CO₂ store can thus be moved together with the cleaning appliance. A relative position between CO₂ store and compressing device then remains unchanged or substantially unchanged, even when the cleaning appliance is moved. In particular, the store receptacle can be configured to accommodate the CO₂ store in a positive-locking or substantially positive-locking manner. In particular, it is advantageous if the store receptacle is configured symmetrically relative to the main plane. The CO₂ store can thus be easily positioned symmetrically on the cleaning appliance relative to the main plane.

It is favorable if the store holding device comprises at least one securing element for the CO₂ store. In this way, it can be prevented, in particular, that the CO₂ store is able to unintentionally release from the cleaning appliance, in particular fall out of the store receptacle. The store holding device can be formed in a simple manner if the at least one securing element is configured in the form of a holding bracket or in the form of a holding band. In particular, two, three, or more securing elements may be provided. In particular, large CO₂ bottles are preferably secured to the cleaning appliance with two or more securing elements.

It is advantageous if the pre-compression device comprises a CO₂ connection, if the CO₂ store is fluidically connected to the CO₂ connection by way of a connecting conduit, and if the CO₂ connection is configured projecting from the pre-compression device in a direction transverse, in particular perpendicular, relative to the direction of gravity. In this way, CO₂ is able to flow, in particular, transversely to the direction of gravity into the pre-compression device, for example into a pre-compression chamber comprised by the pre-compression device. For example, an expansion device, in particular comprising an expansion nozzle, can be arranged downstream from the CO₂ connection in order to be able to conduct the pressurized CO₂ gas or the liquid CO₂ into the pre-compression device and expand it to form CO₂ snow.

It is favorable if a switching device is arranged or formed between the CO₂ connection and the pre-compression device for opening and closing a fluidic connection between the CO₂ connection and the pre-compression device. The switching device makes it possible, in particular, to control a CO₂ stream into the pre-compression device in a desired manner. The switching device may comprise, for example, an electrically or electromagnetically actuatable valve in order to open or to close the fluidic connection in a desired manner, for example in a cycled manner.

In order to further improve the handling of the cleaning appliance, it is advantageous if the cleaning appliance is of mobile configuration and comprises a chassis. Thus, in particular, it can be moved to a point of use by one single person in a simple manner.

The cleaning appliance can be moved, for example pushed, in a desired manner, if the chassis comprises at least three wheels and if at least one of the three wheels is of steerable configuration. For example, the at least one steerable wheel may be configured in the form of a steering roller. Optionally, the steering roller can be equipped with a fixing device in order to prevent the cleaning appliance from unintentionally rolling away, for example on a sloping ground. In addition, an operational safety of the cleaning appliance can thus be increased. The chassis may also comprise more than three wheels, however, for example four. In particular, two non-steerable wheels and two steerable wheels may be provided. The cleaning appliance can be securely moved in this way. A risk of the cleaning appliance tipping over can thus also be significantly reduced. In particular, the main axis wheels may alternatively or additionally be equipped with a fixing device or a braking device in order to prevent the cleaning appliance from rolling away.

In order to further improve a stability of the cleaning appliance, it is favorable if the chassis defines a main axis and if two wheels of the chassis are configured in the form of two main axis wheels arranged or formed so as to be rotatable about the main axis. In this case, the main axis is a virtual axis of rotation, i.e. in the mathematical sense, of the two main axis wheels. This configuration can contribute, in particular, to further reducing a risk of the cleaning appliance tipping over.

It is favorable if the main axis wheels define a main axes wheel diameter, if the at least one wheel of steerable configuration defines a steering wheel diameter, and if the main axis wheel diameter is greater than the steering wheel diameter. In particular, the main axis wheel diameter may be at least about twice as great, further in particular about three times as great, as the steering wheel diameter. The smaller the wheels of steerable configuration are, the more mobile the cleaning appliance is. Large main axis wheels have the advantage, in particular, of defining a greatest possible standing surface for the cleaning appliance if a center of gravity of the cleaning appliance is located near the main axis.

It is favorable if the chassis comprises a chassis frame and if the main axis wheels are arranged or formed projecting laterally beyond the chassis frame. The greater a distance of the two main axis wheels from one another is, the lower a risk of the cleaning appliance tipping over is. However, for a mobility of the cleaning appliance it is advantageous if a distance of two wheels of steerable configuration is smaller than a distance of the two main axis wheels.

In order to further reduce a risk of the cleaning appliance tipping over, it is advantageous if the store holding device is arranged or formed in such a way that the CO₂ store is positioned over the main axis. This enables, in particular, a stable arrangement of the CO₂ store on the cleaning appliance with minimal risk of the cleaning appliance tipping over.

The bottle longitudinal axis preferably intersects the main axis. This makes it possible, in particular, for the center of gravity of the CO₂ store to lie directly on the main axis. One option could also be to position the CO₂ store such that the bottle longitudinal axis is arranged in the region between the main axis wheels and the at least one steerable wheel.

In order to keep an overhang of the cleaning appliance as minimal as possible, it is advantageous if the at least one steerable wheel is arranged or formed under the chassis frame.

In accordance with a further preferred embodiment of the invention, provision may be made, in particular also in the case of a cleaning appliance of the kind described at the outset, that the cleaning appliance comprises a blasting conduit connection for connecting to a first free end of a mixed jet conduit and if the blasting conduit connection is arranged or formed projecting transversely, in particular perpendicularly, to the direction of gravity. Such an arrangement makes it possible, in particular, to connect the cleaning appliance to a mixed jet conduit in a simple manner. For example, the blasting conduit connection may be arranged or formed on an arbitrary side of the cleaning appliance.

The blasting conduit connection is favorably arranged or formed higher than the main axis relative to the direction of gravity. In this way, a mixed jet conduit can be conveniently connected to the cleaning appliance by a user.

In order to be able to securely use the cleaning appliance, in particular under cramped conditions, it is advantageous if the blasting conduit connection and the main axis extend transversely, in particular perpendicularly, to one another. For example, the blasting conduit connection can project from the cleaning appliance at a front end of the cleaning appliance in parallel to the main plane or lying in the main axis plane.

The blasting conduit connection is particularly easily accessible if it extends in parallel to the main plane. In particular, the blasting conduit connection may be configured symmetrically relative to the main plane. CO₂ pellets can thus be guided in a mixed steam, in particular with minimal changes in direction in the region of the cleaning appliance.

In order to improve the handleability of the cleaning appliance, it is advantageous if the blasting conduit connection and the CO₂ connection are arranged or formed pointing in linearly independent directions. In particular, the blasting conduit connection and the CO₂ connection can be arranged or formed pointing in opposite directions. For example, on one side of the cleaning appliance CO₂ can be fed to the compressing device, on the other side of the cleaning appliance the mixed stream of a pressurized gas and the CO₂ pellets can be conducted out of the cleaning appliance.

In accordance with a further preferred embodiment of the invention, in particular in the case of a cleaning appliance of the kind stated at the outset, provision may be made that the cleaning appliance comprises a housing, that the housing defines a housing inner space, and that the compressing device is arranged or formed at least partially, in particular completely, in the housing inner space. The compressing device can thus be arranged, in particular, in a protected manner. Furthermore, the housing may also be of sound-insulated configuration in order to minimize a noise development, in particular of the compressing device. In particular, the pre-compression device and the main compressing device may be arranged or formed together in the housing. It can thus be prevented, in particular, that a user comes into contact with very cold surfaces of the cleaning appliance and suffers frostbite. Optionally, a delivery device for delivering CO₂ pellets that are formed with the compressing device into a pressure conduit that is being flowed through by the pressurized gas may also be arranged within the housing, i.e. in particular in the housing inner space. The housing can thus, in particular, also protect a user from injury, should components of the cleaning apparatus that are under pressure burst.

The cleaning appliance can be maintained and repaired in a simple manner if the chassis closes or substantially closes the housing from the bottom relative to the direction of gravity. This makes it possible, in particular, to remove the housing from the chassis in a simple manner. In particular, the housing can be placed on the chassis frame in such a way that the chassis frame closes or substantially closes the housing from the bottom relative to the direction of gravity.

The cleaning appliance can be configured in a particularly compact manner if the store holding device is molded onto the housing at least in sections. This makes it possible, in particular, to forgo additional components, which would increase an assembly expenditure of the cleaning appliance.

The housing can be made from a plastic material in a simple and cost-effective manner. For example, it may be made by injection molding or in a rotational molding process. In principle, the housing may be formed using any off-tool or tool-forming process.

The housing preferably comprises a handlebar for holding and pushing the cleaning appliance. A user can thus move the cleaning appliance in a particularly simple and convenient manner, in particular if it is of mobile configuration. It is favorable if the handlebar is arranged or formed immovably on the housing. For example, it may be integrated into the housing, such that a user engages directly on the housing when they wish to move, for example push, the cleaning appliance in a desired direction. In this way, no additional moving parts are required, in particular no steering arrangement coupling the handlebar and at least one steerable wheel in a jointed manner, in order to thus specify, for example, an orientation of steerable wheels by way of the handlebar.

It is favorable if the cleaning appliance has a CO₂ housing connection and if the CO₂ housing connection is arranged or formed projecting from the housing on the outside. For example, a CO₂ store can thus be fluidically connected to the CO₂ housing connection in order to conduct liquid or gaseous CO₂ from the CO₂ store to the compressing device. The CO₂ housing connection does not necessarily have to be connected to the housing. In particular, the CO₂ housing connection may comprise a connecting piece projecting out of the housing.

The CO₂ housing connection is preferably arranged or formed projecting in parallel or substantially in parallel to the direction of gravity. For example, it can thus be accessible on the cleaning appliance from the top or from the bottom in order to fluidically connect it to a CO₂ store. In particular, the CO₂ housing connection may be arranged or formed pointing in the direction of gravity or counter to the direction of gravity.

The CO₂ housing connection and the CO₂ connection are favorably connected to one another by way of a CO₂ conduit. If both connections are provided in a spatially defined arrangement to one another, in particular, a rigid or substantially inflexible CO₂ conduit may be provided in order to connect the two connections to one another. For connecting the CO₂ housing connection to a CO₂ store, in particular, a flexible or substantially flexible connecting conduit may be provided, for example in the form of a hose, in particular in the form of a corrugated hose made of metal.

The CO₂ conduit is preferably of inflexible or substantially inflexible configuration. For example, the CO₂ conduit may be configured in the form of a pipe, thereby making the CO₂ conduit of substantially rigid configuration. A certain flexibility can also be set for the CO₂ conduit, however, if it is made of a pipe, namely if the pipe is coiled in one or more windings, i.e. for example in the shape of a spiral. Thus, in particular, movements between the compressing device and the CO₂ housing connection can be compensated for by the CO₂ conduit, which is this case has a certain flexibility.

It is advantageous if the CO₂ conduit defines at least one closed winding. In particular when the CO₂ conduit is made from a pipe, for example a metal pipe, the CO₂ conduit can thus be equipped with a certain flexibility, in particular in order to compensate for relative movements between the compressing device and the housing. The CO₂ conduit can be arranged and formed in a particularly compact manner if the at least one winding defines a winding plane, which extends transversely, in particular perpendicularly, to the main plane and in parallel or substantially in parallel to the direction of gravity.

In accordance with a further preferred embodiment of the invention, provision may be made, in particular in the case of a cleaning appliance of the kind described at the outset, that the cleaning appliance comprises a pressurized gas connection for connecting to a pressurized gas source. By way of the pressurized gas connection, in particular, a pressurized gas can be supplied to the cleaning appliance, which forms a carrier gas for the CO₂ pellets, thus also part of a mixed stream with which the surfaces to be treated are to be acted upon. The pressurized gas source may be comprised, in particular, by the cleaning appliance, for example in the form of a pressurized air compressor, or be provided by a user as a separate unit, for example by a compressor or a bottle-shaped compressed gas store that is separate from the cleaning appliance. In particular, air, nitrogen, or CO₂ may be used as pressurized gas.

It is favorable if the cleaning appliance comprises a pellet delivery device for delivering CO₂ pellets into a pressurized gas stream and if the pressurized gas connection is fluidically connected to the pellet delivery device. This configuration makes it possible, in particular, to introduce CO₂ pellets into a pressurized gas stream in a defined manner with the pellet delivery device for forming the desired mixed steam of the pressurized gas serving as a carrier gas and the CO₂ pellets.

The pellet delivery device is favorably fluidically connected to the blasting conduit connection. The mixed stream of carrier gas or pressurized gas and CO₂ pellets can thus be guided directly from the pellet delivery device to the blasting conduit connection.

The pellet delivery device favorably comprises a dosing device for dosing a number of CO₂ pellets and/or a CO₂ pellet volume before the delivery into the pressurized gas stream. This enables a user, in particular, to set the mixed stream in the desired manner, i.e., for example, whether a large amount or a small amount of CO₂ pellets are to be delivered into the pressurized gas stream for acting upon the surface to be treated or not.

In order for a user to be able to activate or deactivate the mixed stream in the desired manner, it is favorable if a pneumatic switching device is arranged or formed between the pressurized gas connection and the pellet delivery device for opening and closing a fluidic connection between the pressurized gas connection and the pellet delivery device. In other words, a pressurized gas stream can thus be interrupted or activated. In this way, a user can treat surfaces in a resource-saving manner, because a mixed stream is produced only when it is actually needed.

The pneumatic switching device can be configured in a simple manner if it comprises at least one pressurized gas valve. The pressurized gas valve can be controlled or actuated, for example, electrically or electromagnetically.

In order to achieve a better overview when using the cleaning appliance, it is advantageous if the pressurized gas connection is arranged or formed in the region of the store holding device. In particular, it may thus be arranged on a side of the cleaning appliance that points, e.g., in the opposite direction relative to that side on which the blasting conduit connection is arranged or formed.

In accordance with a further preferred embodiment of the invention, in particular also in the case of a cleaning appliance of the kind described at the outset, provision may be made that the cleaning appliance comprises a control and/or regulating device for controlling and/or regulating the cleaning appliance. In particular, the compressing device, for example the pre-compression device and/or the main compressing device, can be controlled and/or regulated with the control and/or regulating device.

The control and/or regulating device is favorably arranged or formed in the housing. In particular, the control and/or regulating device may be of two-part or multi-part configuration, for example it may comprise an electronic control that is arranged spatially separate from motor protection switches of an electric motor comprised by the drive device. In particular, all components of the control and/or regulating device may be arranged or formed in the housing. In this way, in particular, they can be arranged protected from contamination. Furthermore, it can thus also be prevented that a user is able to come into contact with, in particular current-carrying, lines and contacts.

It is advantageous if the control and/or regulating device is arranged or formed at least partially below the compressing device and at least partially above the compressing device relative to the direction of gravity. For example, components of the control and/or regulating device that serve for switching the drive device may be arranged below the compressing device, i.e. preferably in the vicinity of the drive device, for example in the vicinity of an electric motor. In contrast, electronic circuits that are arranged or formed on circuit boards may preferably be arranged above the compressing device, for example in the region of the handlebar of the cleaning appliance. In particular, these components may be arranged or formed in a separate compartment of the housing, for example a recess of the housing provided for this purpose. Thus, these component can, in particular, be additionally protected, namely from environmental influences on the cleaning appliance on the one hand and from low temperatures prevailing in the region of the compressing device on the other hand.

The control and/or regulating device is favorably configured to control the compressing device in such a way that mechanical properties of the CO₂ pellets to be produced are specifiable. In particular, for example, a density of the CO₂ pellets can thus be specified. Alternatively, for example, a size of the CO₂ pellets can also be set.

The control and/or regulating device advantageously comprises an input device for specifying the mechanical properties and/or a number of CO₂ pellets to be produced. Mechanical properties of the CO₂ pellets are, in particular, their density and their size. For example, the input device may be configured to provide a user two, three, or more settings with which a size of the CO₂ pellets can be specified. Furthermore, a density of the CO₂ pellets can optionally be specified in one, two, three, or more levels. Optionally, an amount, i.e., in particular a number of CO₂ pellets to be produced, can also be specified by way of the input device. In particular, different input elements, for example selector switches, may be provided for, e.g., the density, the size, and the number of CO₂ pellets to be produced.

The cleaning appliance can be operated in a simple manner if the input device is arranged or formed on the housing. A user thus has direct access to the input device and can set the desired specifications, for example for density, size, and number of pellets to be produced, by way of the input device.

The input device is favorably configured to be releasably connectable to the housing. For example, the input device can close a recess formed on the housing, in which electronic circuits of the control and/or regulating device are arranged or formed. In order to grant access to the circuitry components, the removability of the input device is advantageous. For example, the input device may comprise a panel on which input elements, for example rotary switches or toggle switches or buttons, are arranged or formed.

The input device favorably comprises an operating mode selector switch for selecting an operating mode of the cleaning appliance. For example, by way of the operating mode selection switch, it can be specified at which speed the mixed stream leaves the blasting conduit connection or with which intensity a surface to be treated can be acted upon with CO₂ pellets, for example by way of the amount or number of CO₂ pellets per unit of time. Alternatively, by way of the operating mode selection switch, in addition or merely a desired pellet amount can be specified, for example “low”, “medium”, or “high”. Optionally, using the operating mode selector switch in a further switch position, a user can reset blasting times, which can be displayed, e.g., on a display device like, for example, an LCD display. A user can thus, for example, record and bill performed service times for a client based on determined blasting times.

It is advantageous if the input device comprises a display device for displaying an operating mode and/or operating parameters of the cleaning appliance. A user can thus, for example, always immediately recognize in which operating mode the cleaning appliance is being operated or which operating parameters are set. The display device may, in particular, form part of a touchscreen, by way of which inputs can also be entered on the input device. For example, the display device may be configured to display an operating time of the cleaning appliance, in particular a blasting time, i.e. that time during which a mixed stream of a pressurized gas and CO₂ pellets is discharged. In addition or alternatively, the display device may also be configured to display or show operating hours of the cleaning appliance, a remaining time until the next maintenance or service of the cleaning appliance, and a set blasting pressure, i.e., in particular, a pressure of the compressed gas. A blasting pressure can optionally be set on the appliance, for example by way of an accessory device comprising a pressure reducer. This accessory device may be arranged, in particular, in the interior of the housing of the cleaning appliance, i.e., in particular, in a housing inner space defined by the housing. The described accessory device may, however, also be arranged or mounted outside on the housing. Alternatively, the blasting pressure can be set by way of an external device, for example a pressure reducer in a workshop or on a compressor providing the pressurized gas.

To improve the handling of the cleaning appliance, it is favorable, in particular, if the handlebar is arranged or formed surrounding the input device. An operator that moves the cleaning appliance can thus directly see the input device and, as the case may be, select settings for the operation of the cleaning appliance on the input device.

It is also advantageous if the input device defines a display plane and if the display plane is inclined relative to the direction of gravity. For example, the angle of inclination may be in an angular range of about 30° to about 60°. An operator standing in front of the cleaning appliance can thus see and operate the input device in an optimal manner.

For the handling of the cleaning appliance, it is further advantageous if the blasting conduit connection is arranged or formed below the input device relative to the direction of gravity. For example, an operator can thus directly see whether a mixed jet conduit is properly coupled to the blasting conduit connection. At the same time, the operator can then also take insight into the input device and activate, operate, and optionally deactivate the cleaning appliance.

The input device is favorably arranged or formed above the at least one steerable wheel relative to the direction of gravity. In particular, an operator can thus move the cleaning appliance, for example, with a handlebar surrounding the input device. It is thus particularly simple, in particular, to steer the cleaning appliance in a desired direction, because the at least one steerable wheel is arranged or formed below the input device surrounded by the handlebar.

In accordance with a further preferred embodiment of the invention, provision may be made, in particular also in the case of a cleaning appliance of the kind described at the outset, that the cleaning appliance comprises an energy supply connection for connecting the cleaning appliance to an energy supply network. In this way, the cleaning appliance can be supplied with energy in order to operate it, in particular the compressing device. The energy supply connection may be configured, in particular, in the form of a current supply connection in order to connect the cleaning appliance to a current supply network. This configuration is advantageous, in particular, if the components comprised by the cleaning appliance are electrical or electronic components for operating the cleaning appliance, for example the drive device, as well as the control and/or regulating device, in particular components comprised thereby.

Furthermore, in a further preferred embodiment of the invention, provision may be made that the cleaning appliance comprises a CO₂ exhaust gas outlet for discharging CO₂ gas that is not solidify in the compressing device or that was formed by sublimation of CO₂ pellets. The CO₂ exhaust gas outlet makes it possible, in particular, to discharge excess CO₂ in a defined manner. If the cleaning appliance is operated, for example, in a closed space, the exhaust gas outlet can thus, for example, be fluidically connected to an environment of the space by way of an exhaust gas hose in order to keep a CO₂ content in the ambient air under a certain threshold value, which must be ensured by a user by way of appropriate ventilation and venting of the space or region in which the cleaning appliance is operated. A user is thus able to safely operate the cleaning appliance. In particular, a user can also ensure by way of suitable measures, for example active ventilation and venting of the space or region in which the cleaning appliance is operated, that enough oxygen remains in the ambient air for a user to breathe.

The CO₂ exhaust gas outlet is favorably fluidically connected to the pellet delivery device and a pellet outlet of the compressing device. A large proportion of excess CO₂ typically arises particularly in the region of the pellet delivery and at the pellet outlet of the compressing device. By means of the proposed further development, as already described, said excess CO₂ can be discharged in a defined manner in order to keep a CO₂ level in the region or in a vicinity of the cleaning appliance at a sufficiently low level.

For the handling of the cleaning appliance, it is favorable if the CO₂ exhaust gas outlet is arranged or formed in the region of the store holding device. In particular, it may be arranged or formed pointing in the opposite or substantially opposite direction relative to the blasting conduit connection. This has the advantage, in particular, that in the case that the input device and the handlebar are arranged or formed above the blasting conduit connection, the CO₂ exhaust gas outlet is arranged or formed on a side of the cleaning appliance that points away from the input device. Excess CO₂ can thus be kept away from a user in a simple manner, who when operating the cleaning appliance is predominantly located on that side of the cleaning appliance on which the blasting conduit connection is arranged or formed.

It is favorable if the cleaning appliance comprises a blasting nozzle and a mixed jet conduit and if the mixed jet conduit connects the blasting conduit connection to the blasting nozzle. This configuration enables a user, in particular, to direct the blasting nozzle at a surface of an object to be treated in the desired manner. The cleaning appliance with the compressing device can thus remain at a particular location or in a particular position during use. A flexible cleaning is possible using the blasting nozzle in connection with the mixed jet conduit.

In order to further improve the handleability of the cleaning appliance, it is advantageous if the cleaning appliance comprises a blasting gun and if the blasting nozzle is arranged or formed on the blasting gun. A blasting gun enables a user, in particular, to use the cleaning appliance in a sensitive manner. For example, one or more actuating elements may be arranged or formed on the blasting gun, with which a user can, for example, activate or deactivate the mixed stream, for example by activating or deactivating a pressurized gas stream. For this purpose, in particular, the blasting gun can be control-operatively connected to the pneumatic switching device described above. If, for example, the actuating element of the blasting gun is activated, a pressurized gas stream can be activated and with a desired flow CO₂ pellets can then also be delivered by the pellet delivery device into the pressurized gas stream. In this case, further CO₂ pellets should then be produced with the compressing device in order to enable a continuous operation of the cleaning appliance. A continuous operation does not necessarily mean that all components of the cleaning appliance are working continuously. For example, the pre-compression device described above can intermittently produce CO₂ snow, which is then compressed by the main compressing device into CO₂ pellets in a continuous manner or as per demand. In particular, when the actuating element of the blasting gun is no longer actuated by the user, the mixed stream of pressurized gas and CO₂ pellets is preferably interrupted, in particular by automatically closing the fluidic connection between the pressurized gas connection and the pellet delivery device.

It is favorable if the cleaning appliance comprises an electrical control connection and at least one control connecting line and if the at least one control connecting line connects the control connection and the blasting gun to one another in a control-operative manner. In this case, the blasting gun is thus connected to the cleaning appliance not only by way of the mixed jet conduit, but also by way of the control connecting line. By way of an actuating element on the blasting gun, in particular, an electrical signal can thus be transmitted from the blasting gun to the control and/or regulating device if it is connected to the electrical control connection in a control-operative manner. Alternatively, the blasting gun can also be connected to the control and/or regulating device by way of a radio connection in order to transmit a pellet request of the user to the control and/or regulating device of the cleaning appliance by actuating an actuating element on the blasting gun.

In order to be able to establish a connection between the blasting gun and the control and/or regulating device in a simple manner, it is advantageous if the control connection and the control and/or regulating device are connected to one another in a control-operative manner.

For the handling of the cleaning appliance, it is advantageous if the control connection is arranged or formed projecting in parallel to the blasting conduit connection. This makes it possible, in particular, to guide the control connecting line and the mixed blasting conduit in parallel to one another from the cleaning appliance to the blasting gun. For example, both lines can be coupled to one another by way of connecting elements in order to prevent tripping hazards being created for a user due to the lines lying in an uncontrolled manner.

It is favorable if the control connection is arranged or formed on the housing. In particular, it may be arranged or formed projecting from the housing transversely to the direction of gravity. The arrangement of the control connection on the housing enables, in particular, a relief of tension on lines in a simple manner. The control connection preferably projects perpendicularly from the housing relative to the direction of gravity.

It is advantageous if the control connection is arranged or formed over the blasting conduit connection relative to the direction of gravity. This makes it possible, in particular, to couple the control connecting line to the control connection only when the mixed jet conduit is already coupled to the blasting conduit connection. It can thus be ensured, in particular, that a mixed stream is not able to exit directly from the blasting conduit connection.

An actuating element is favorably arranged or formed on the blasting gun for activating and deactivating a mixed stream of a pressurized gas and CO₂ pellets. A user can thus, for example, direct the blasting gun with the blasting nozzle at an object to be cleaned and then request a mixed stream of pressurized gas and CO₂ pellets by actuating the actuating element. Said mixed stream can then be correspondingly delivered by the cleaning appliance by the pressurized gas conduit being opened and the compressing device being activated to produce CO₂ pellets.

The cleaning appliance preferably comprises a blasting nozzle holding device for holding the blasting nozzle in a storage position. This enables a user to store the blasting nozzle, in particular if it is arranged or formed on a blasting gun with an actuating element, on the cleaning appliance in a defined manner when the cleaning appliance is not needed.

The blasting nozzle holding device can be formed in a simple and cost-effective manner if it is integrated into the housing or is molded onto the housing. For example, the blasting nozzle device may comprise a C-shaped receptacle for the blasting gun.

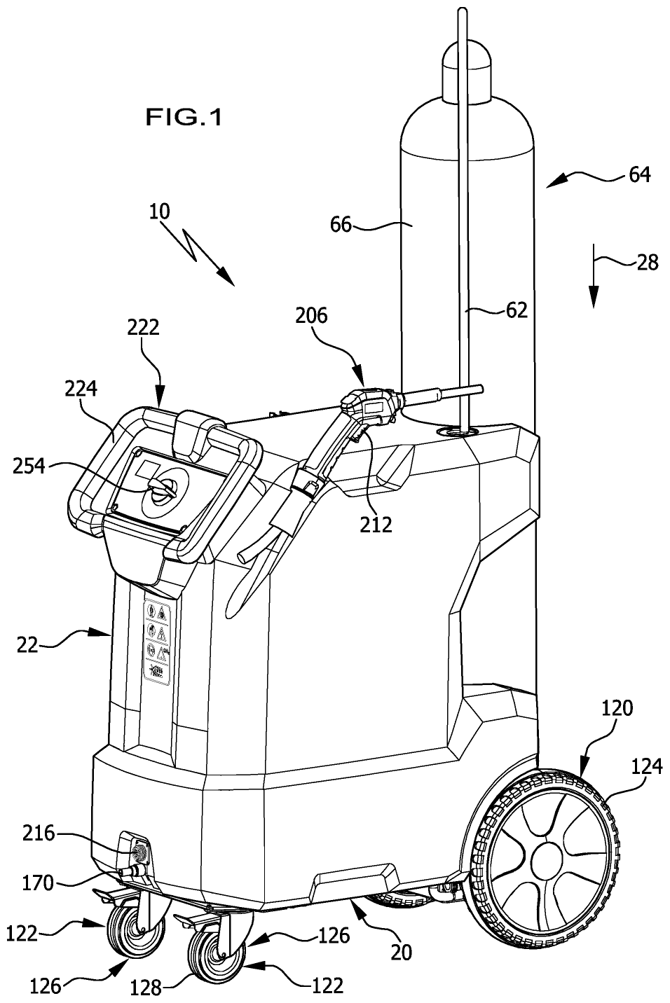

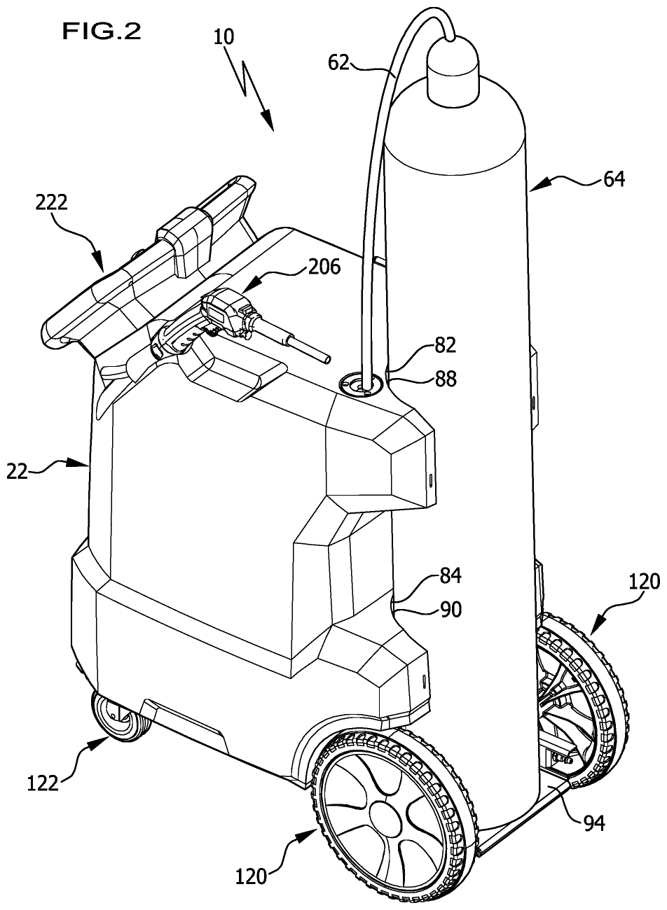

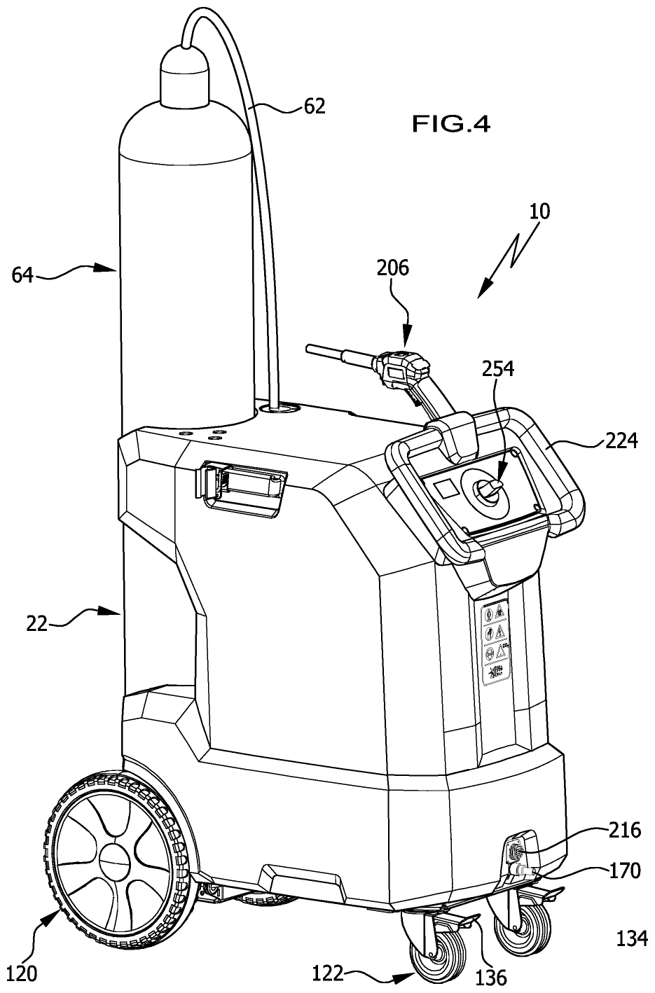

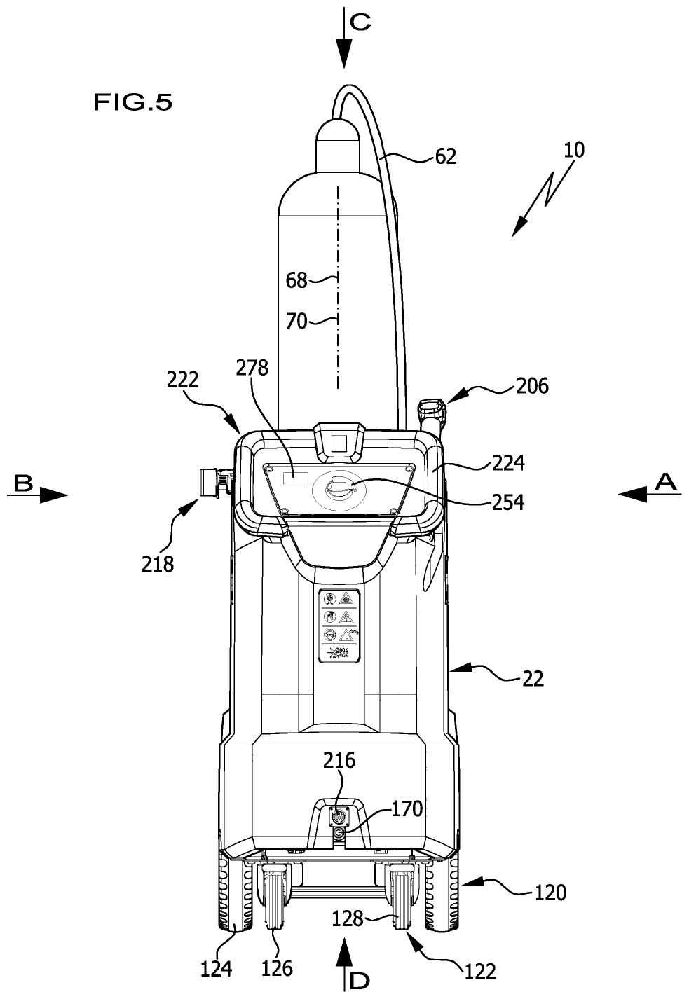

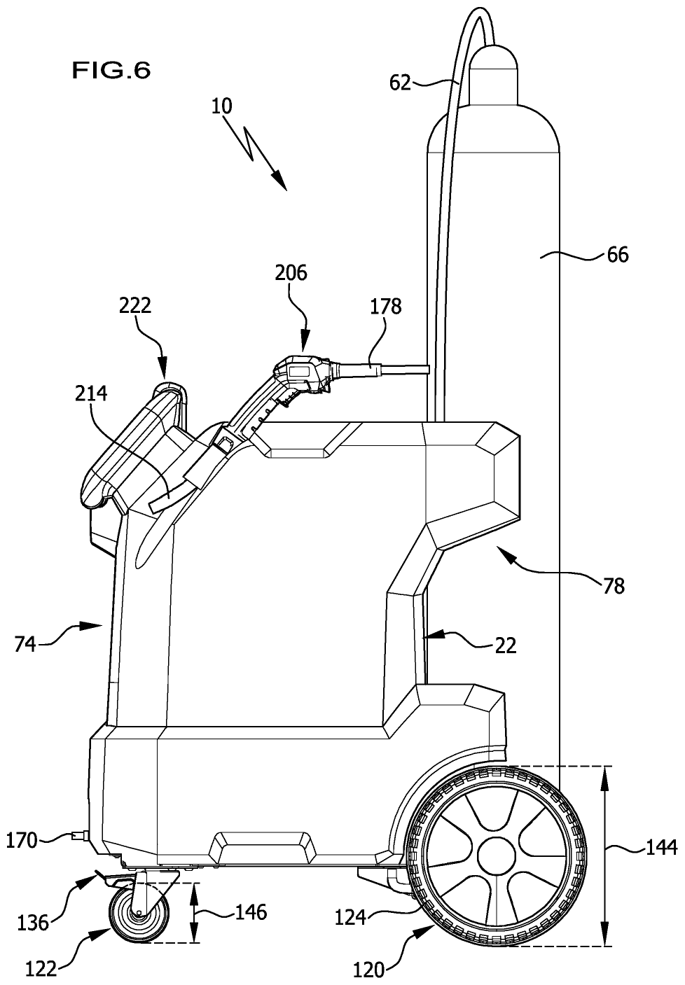

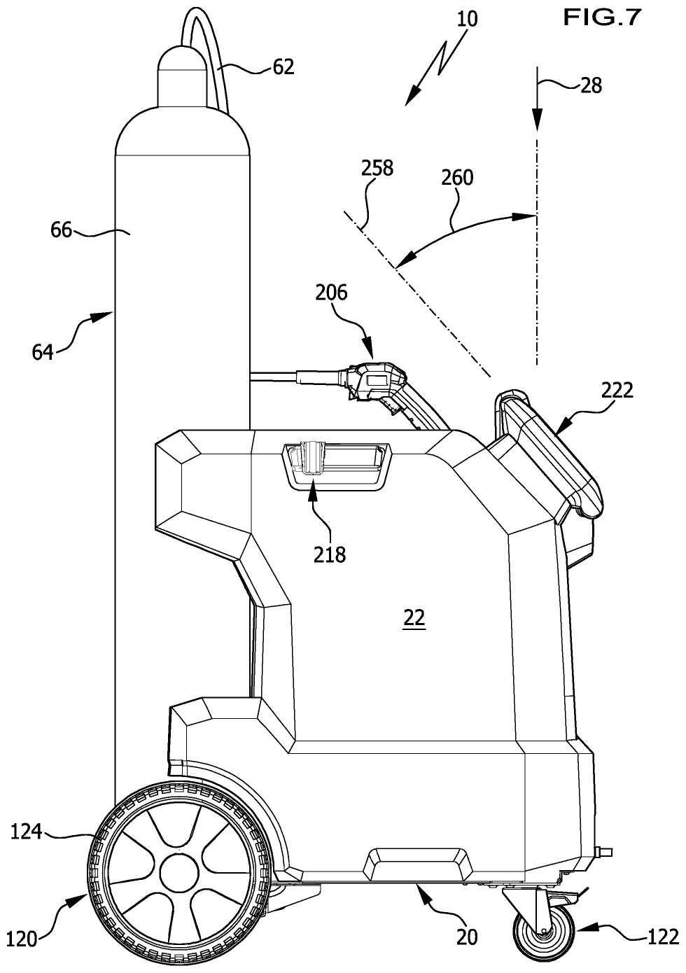

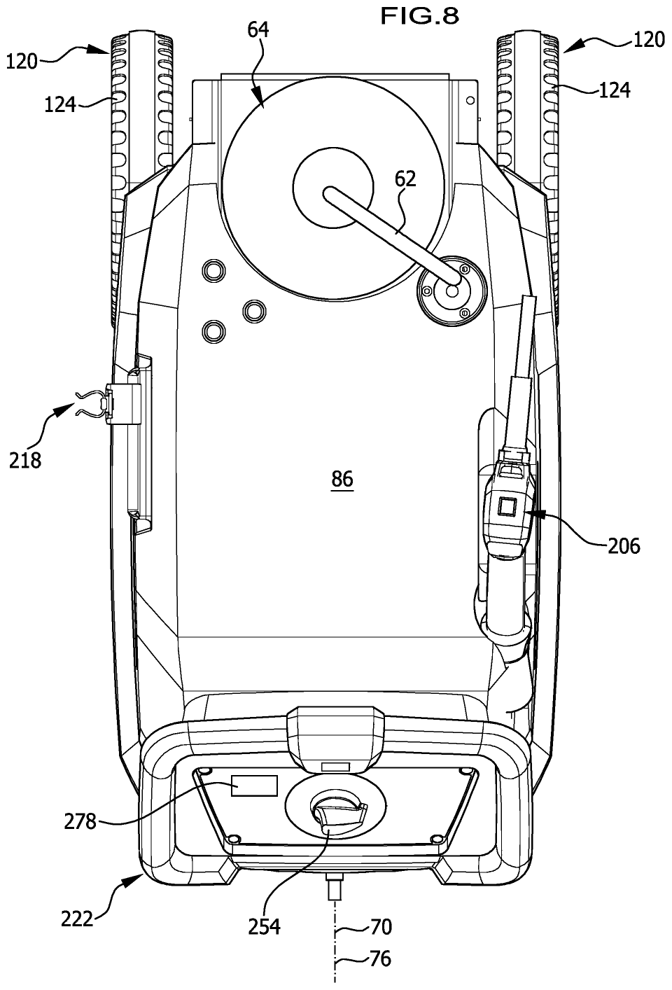

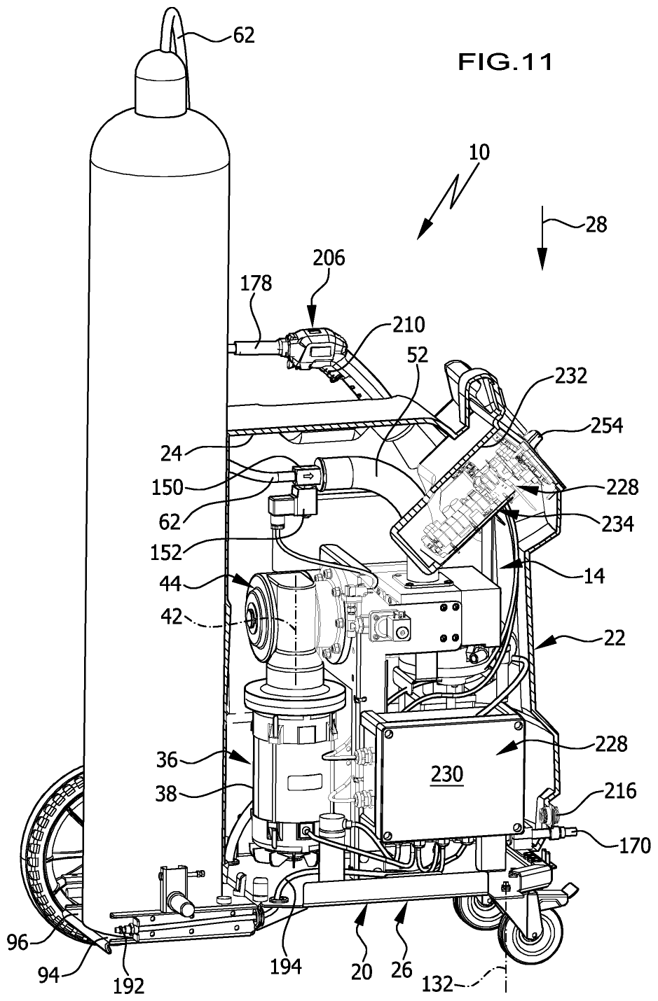

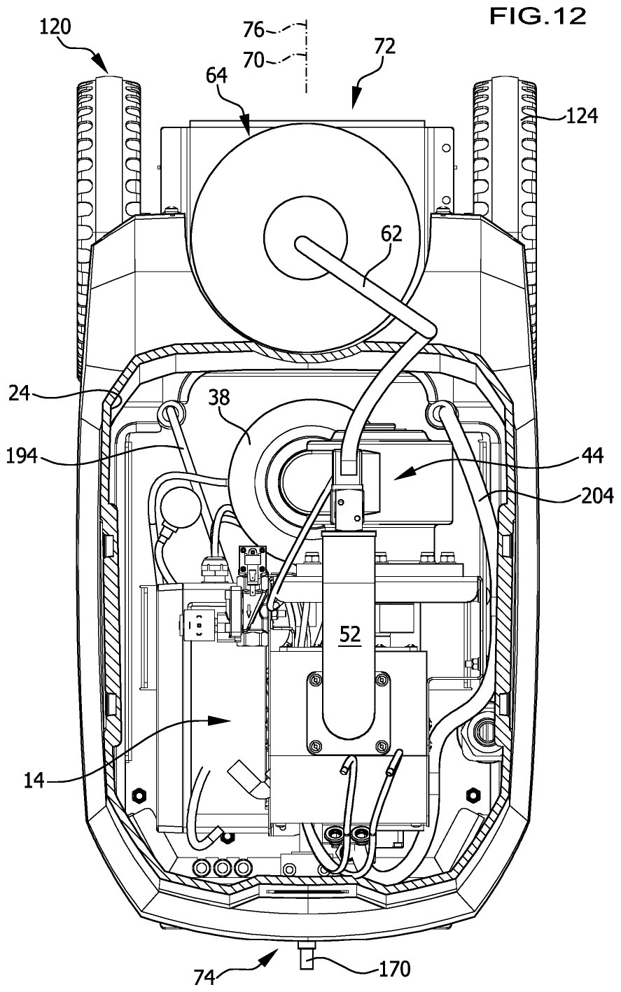

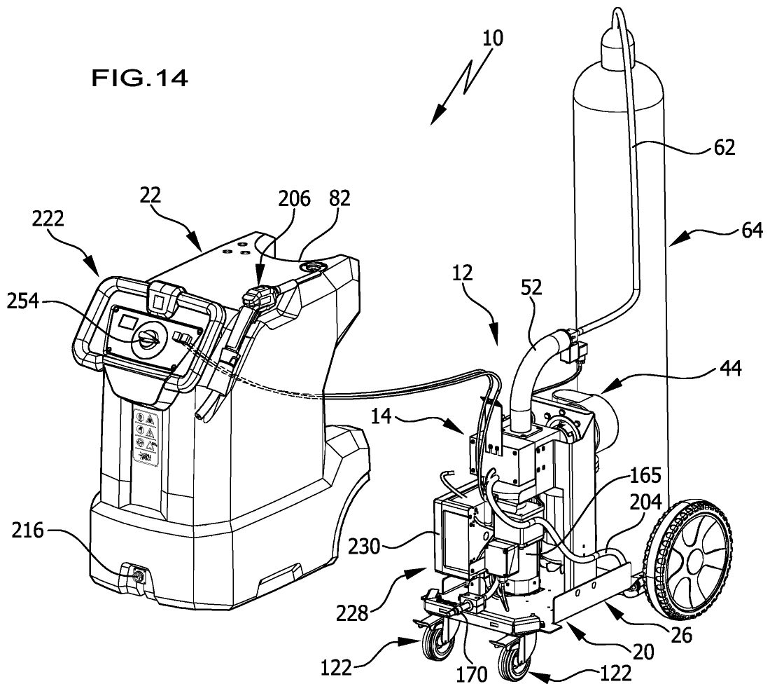

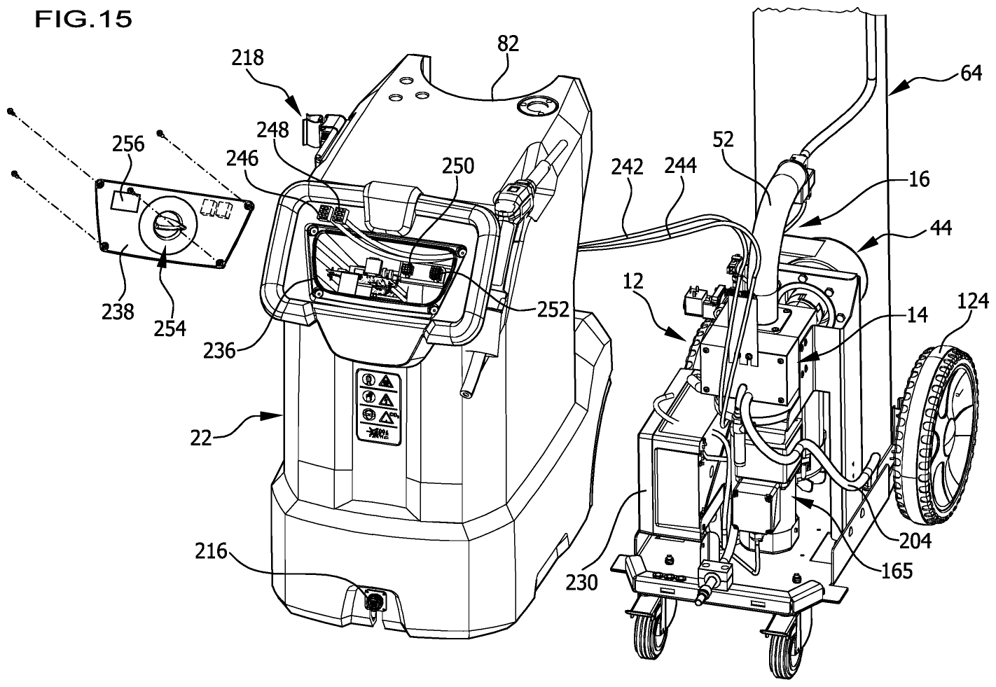

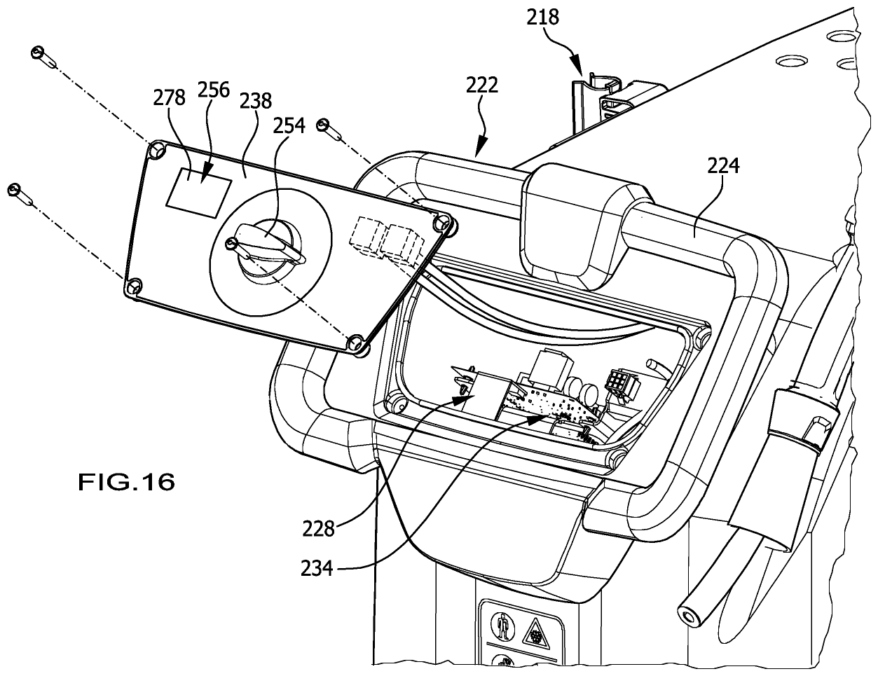

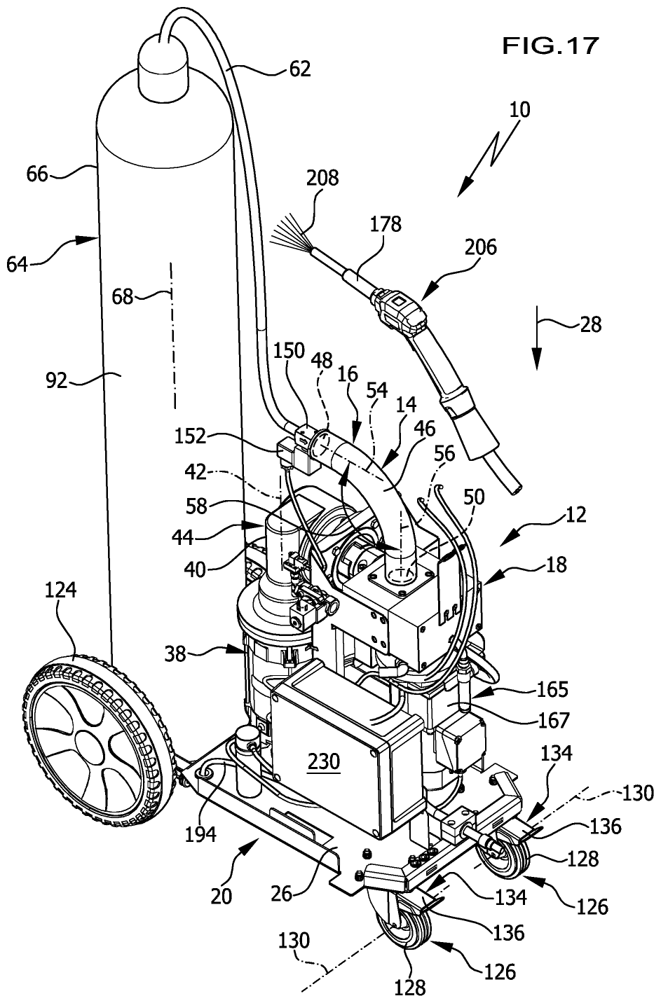

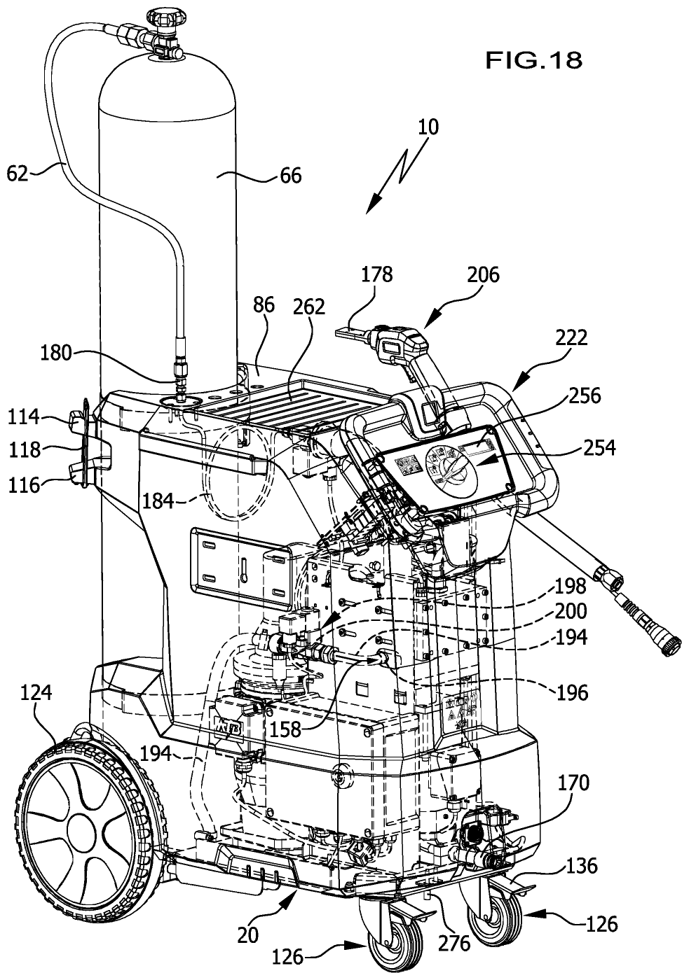

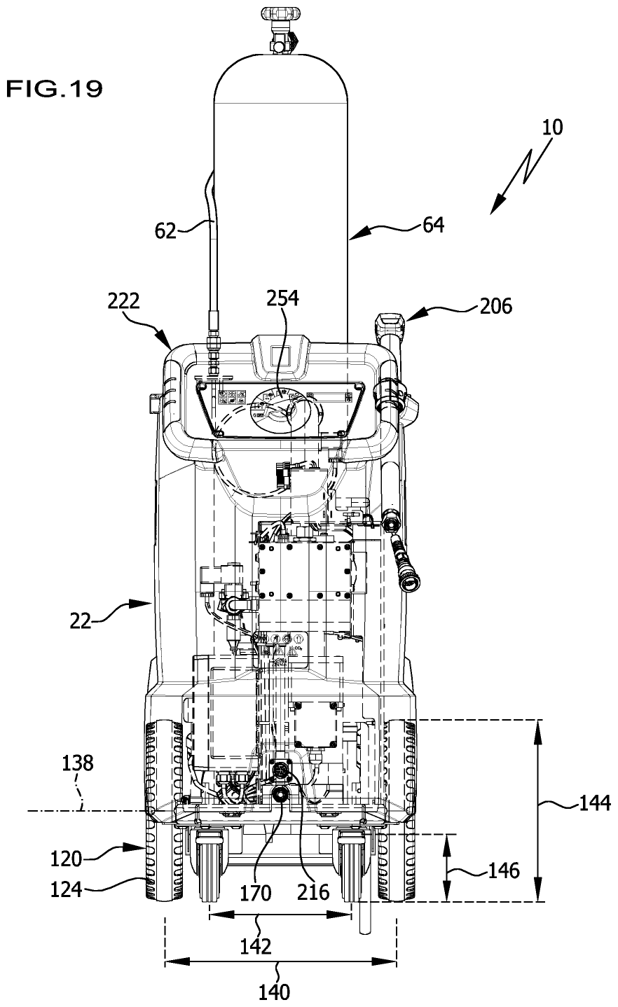

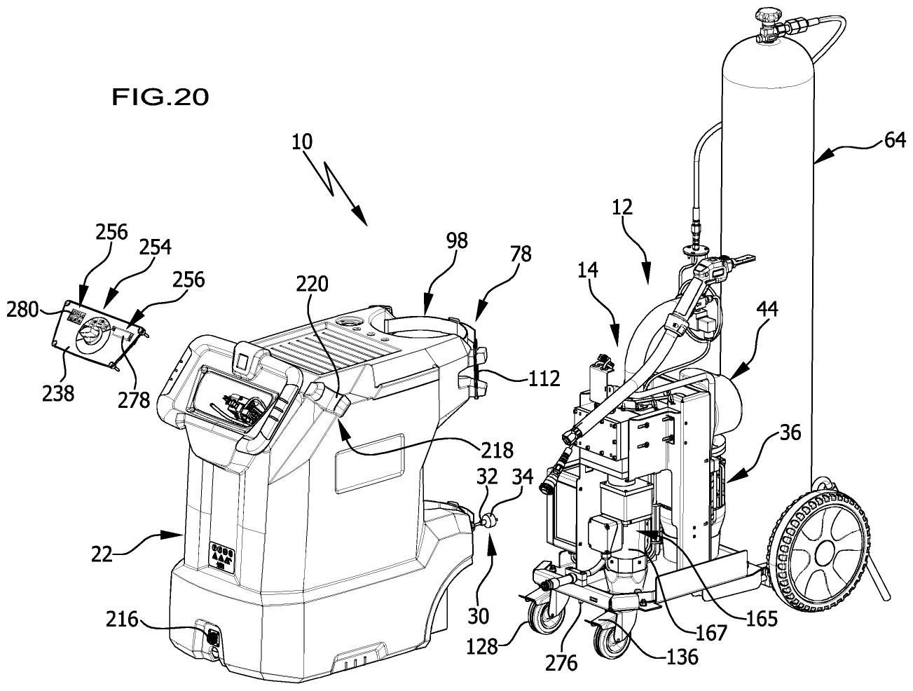

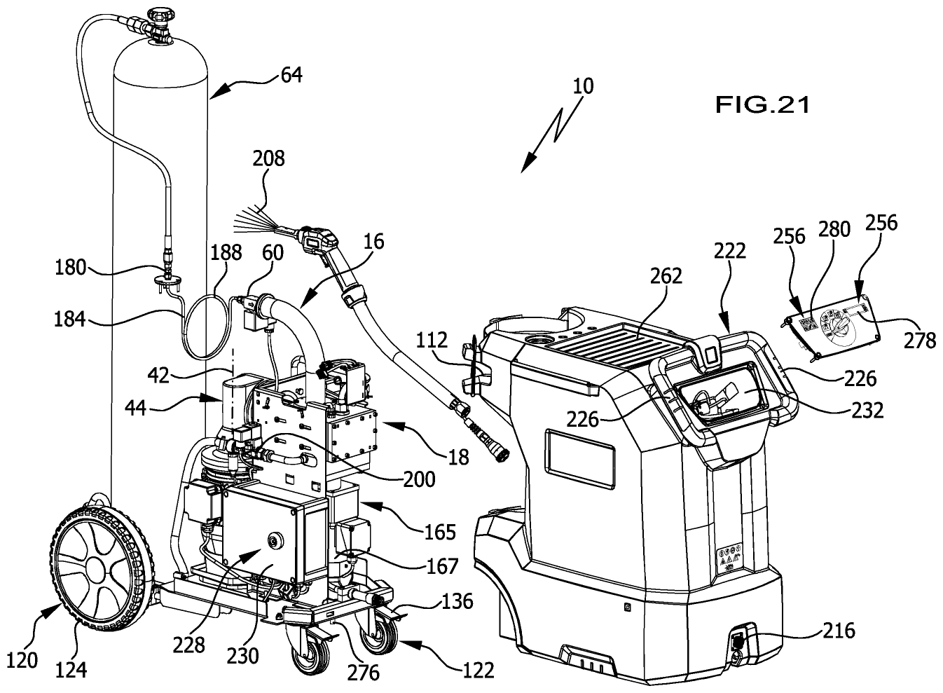

Schematically depicted in FIGS. 1 to 17 is a first embodiment of a cleaning appliance for blasting surfaces to be treated with a mixed stream of a pressurized gas and CO₂ pellets. Furthermore, a second embodiment of a cleaning appliance is schematically depicted in FIGS. 18 to 23 and is also denoted with the reference numeral 10. The two embodiments differ only in details, such that for the sake of clarity identical reference numerals are used for denoting identical or functionally similar components.

The subsequent description serves to explain both embodiments. In the case of the differences between the two embodiments, the differences are explained in detail in connection with FIGS. 1 to 17.

The cleaning appliance 10 comprises an apparatus 12 for producing CO₂ pellets from liquid or gaseous CO₂.

The apparatus 12 comprises a compressing device 14 for compressing CO₂ snow to form CO₂ pellets.

The compressing device 14 comprises a pre-compression device 16 and a main compressing device 18. The two devices are explained in more detail in the following.

Furthermore, the cleaning appliance 10 is of mobile configuration and comprises a chassis 20.

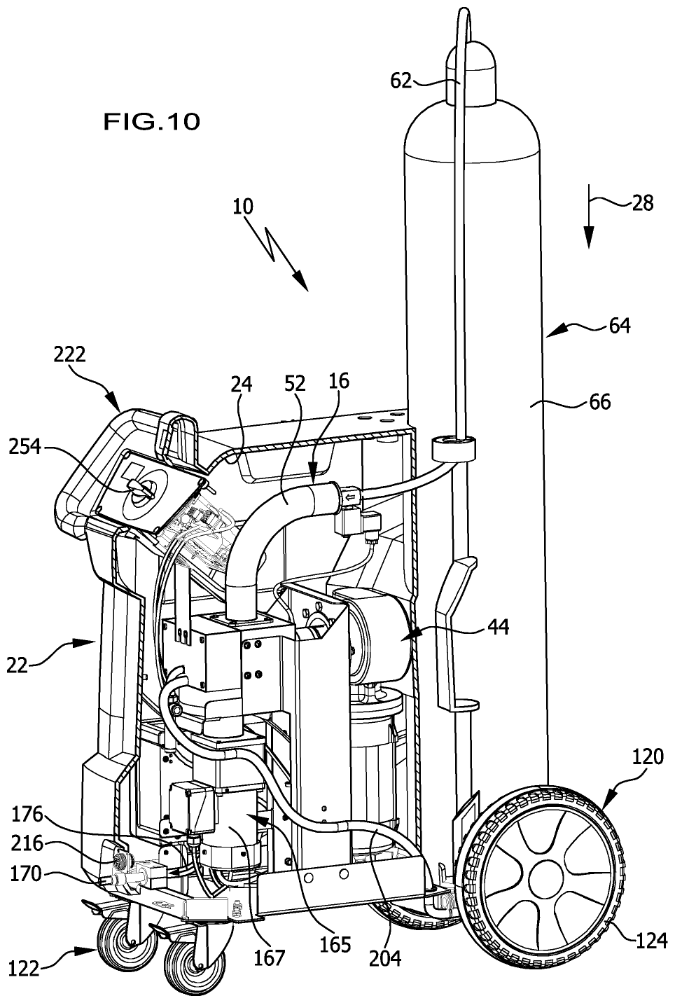

Furthermore, the cleaning appliance 10 comprises a housing 22, which defines a housing inner space 24. In the embodiments depicted in the Figures, the compressing device 14 is accommodated in the housing inner space 24, as is schematically depicted in FIGS. 10 to 12 and 18.

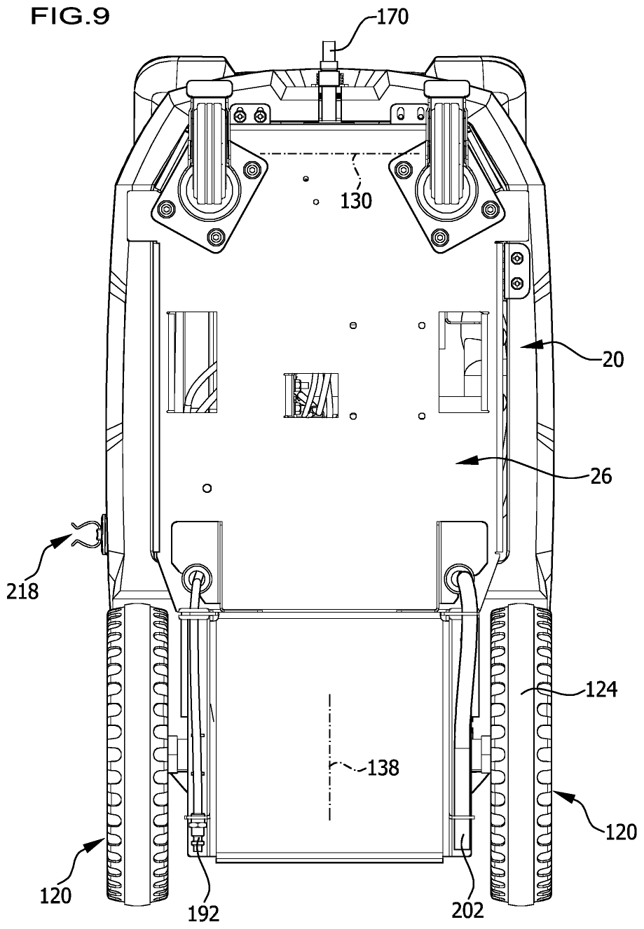

The chassis 20 comprises a chassis frame 26. As can be seen in particular in FIG. 9, the chassis 20 closes the housing 22 from the bottom with the chassis frame 26 relative to the direction of gravity 28 symbolized by an arrow.

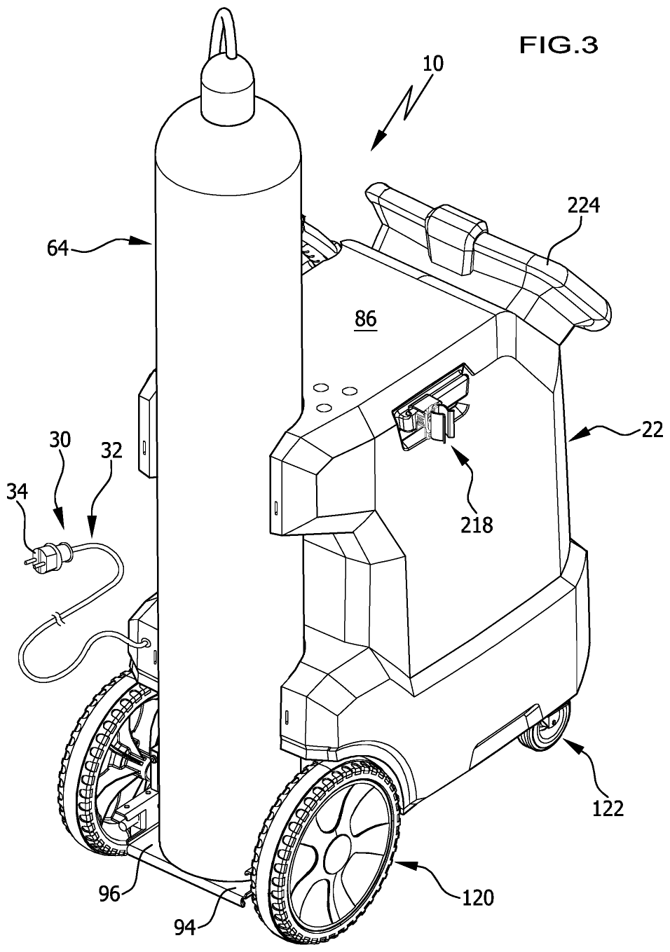

The cleaning appliance 10 further comprises an energy supply connection 30 in the form of a current supply connection with a connection plug 34 for connecting the cleaning appliance to an energy supply network, for example a current supply network, which is not depicted in the Figures. In the case of the embodiment depicted in FIGS. 1 to 17, the energy supply connection 30 is shown only in FIG. 3 as an example.

For driving the compressing device 14 the cleaning appliance 10 comprises a drive device 36, which in the embodiments depicted in the Figures comprises an electric motor 38.

The drive device 36 comprises a drive shaft, which is not depicted in more detail in the Figures and is surrounded in a protective manner by a cylindrical housing part 40 of a transmission 44, which is configured as an angular gearbox. The drive shaft defines a drive shaft axis 42, which, during the intended use of the cleaning appliance 10, extends in parallel or substantially in parallel to the direction of gravity 28. In other words, the electric motor 38 is installed vertically.

The drive device 36 is coupled to the transmission 44. The transmission 44 is coupled with its drive shaft to the compressing device 44 in a driving manner. The drive shaft of the transmission 44 extends perpendicularly to the direction of gravity 28.

The pre-compression device 16 of the cleaning appliance 10 is configured to pre-compress CO₂ snow, which is formed by expanding liquid CO₂ or by expanding pressurized CO₂.

The embodiments depicted in the Figures comprise a pre-compression device 16 in the form of a fluid mechanical pre-compression device 16. This means that the CO₂ snow is formed and pre-compressed solely by a flow of CO₂ gas guided in a spatially defined manner.

The fluid mechanical pre-compression device 16 comprises a pre-compression chamber 46. The pre-compression chamber 46 comprises a pre-compression chamber inlet 48 and a pre-compression chamber outlet 50. The pre-compression chamber 46 is of curved configuration between the pre-compression chamber inlet 48 and the pre-compression chamber outlet 50. The pre-compression chamber 46 comprises a curved pipe 52.

The pre-compression chamber inlet 48 defines an inlet longitudinal axis 54. The pre-compression chamber outlet 50 defines an outlet longitudinal axis 56. The inlet longitudinal axis 54 and the outlet longitudinal axis 56 enclose between them an angle of curvature, which in the embodiments depicted in the Figures is about 90°.

The pipe 52 is arranged in such a way that the inlet longitudinal axis 54 extends transversely, in particular perpendicularly, to the direction of gravity 28. The outlet longitudinal axis 56, by contrast, extends in parallel or substantially in parallel to the direction of gravity 28.

The pre-compression chamber outlet 50 is arranged or formed above or over the main compressing device 18 relative to the direction of gravity 28. The pre-compression device 16 comprises a CO₂ connection 60. The CO₂ connection 60 is fluidically connected to a CO₂ store 64 by way of a connecting conduit 62. The CO₂ store 64 contains liquid CO₂, provided the pressure in the CO₂ store 64 is higher than 5.2 bar. In the case of lower pressure in the CO₂ store 64, the CO₂ contained therein is gaseous.

In the embodiments depicted in the Figures, the CO₂ store 64 is configured in the form of a CO₂ bottle 66, which defines a bottle longitudinal axis 68, which, during the intended use of the cleaning appliance 10, i.e., in particular, in an orientation as it is depicted in the Figures, is oriented in parallel or substantially in parallel to the direction of gravity 28.

At this point it should be noted that the cleaning appliance 10 defines a main plane 70, which extends in parallel to the direction of gravity 28 and reaches from a rear side 72 to a front side 74 of the cleaning appliance 10. In the embodiments depicted in the Figures, the main plane 70 substantially defines a symmetry plane 76 of the cleaning appliance 10. This means that the cleaning appliance 10 is configured at least partially symmetrically, namely mirror-symmetrically, relative to the symmetry plane 76. For example, the housing 22 is configured substantially symmetrical to the symmetry plane 76 and thus also to the main plane 70.

As can be easily seen in the Figures, the drive shaft axis 72 of the drive shaft of the drive device 36 extends in the main plane 70. The drive device 36 is also positioned near the rear side 72 above the chassis frame 26 relative to the direction of gravity 28.

The bottle longitudinal axis 68 of the CO₂ store 64 is also positioned extending in the main plane 70 or near it. As can be easily seen in the Figures, the CO₂ store 64 is arranged symmetrically relative to the main plane 70, namely on the rear side 72 of the cleaning appliance 10.

Furthermore, the pipe 52 comprised by the pre-compression device 16 extends in parallel or substantially in parallel to the main plane 70. The pre-compression chamber inlet 48 points in the direction of the rear side 72, thus in the direction toward the CO₂ store 64.

A store holding device 78 is provided on the cleaning appliance 10 for the CO₂ store 64. The store holding device 78 defines a store receptacle 80 for the CO₂ store 64. The store receptacle 80 is configured symmetrically relative to the main plane 70 and is open pointing to the rear away from the rear side 72. The store holding device 78 is molded onto the housing 22 in sections. It comprises an upper recess 82 and a lower recess 84.

The two recesses 82 and 84 are formed at a distance from one another relative to the direction of gravity 28. The lower recess 84 is positioned somewhat above the chassis frame 26. The upper recess 82 extends commencing from a top side 86 of the housing somewhat in the direction of gravity 28 toward the lower recess 84. The two recesses 82 and 84 define respective hollow-cylindrical wall faces 88 and 90, which are in alignment with one another and have a radius of curvature that is only slightly greater than a radius of curvature of the CO₂ bottle 66 relative to its bottle longitudinal axis 68, such that an outer cylindrical wall face 92 of the CO₂ bottle 66 contacts the wall faces 88 and 90 when the CO₂ store 64 is properly positioned in the store holding device 78.

The store holding device 78 further comprises a support plate 94, which extends to the rear away from the chassis frame 26 and defines a planar standing surface 96 for the CO₂ store 64.

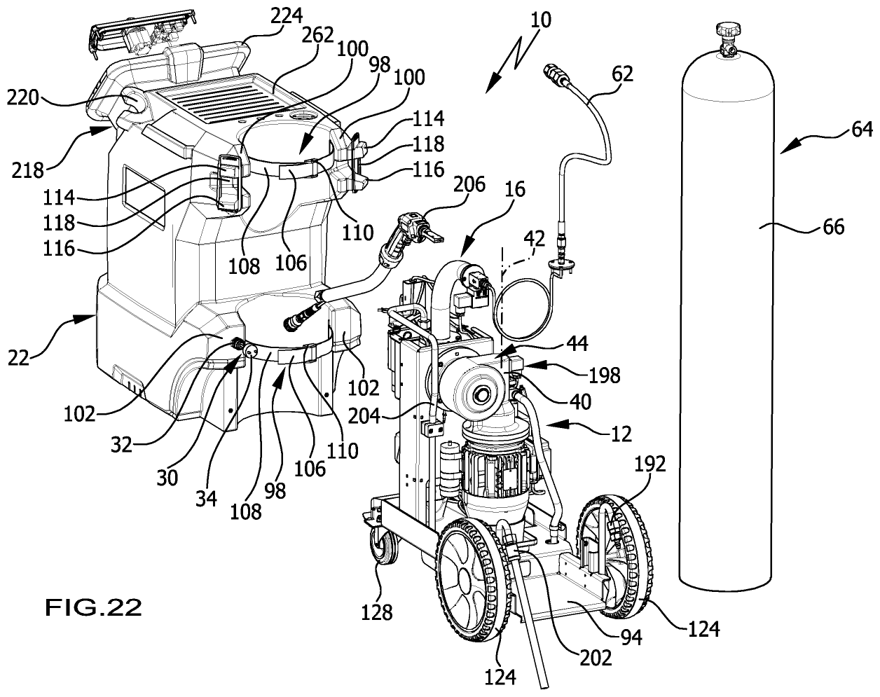

The store holding device 78 further comprises securing elements 98 for the CO₂ store 64. In the embodiment of the cleaning appliance 10 in accordance with FIGS. 18 to 23, two securing elements 98 are provided, which connect together respective free ends 100 and 102 of rearwardly projecting projections that delimit the recesses 82 and 84. The securing elements 98, as they are schematically depicted in FIG. 22, each comprise two band portions 106 and 108 extending away from the respective ends 100 and 102, which are in engagement with one another by way of a closure element 110 so that the CO₂ bottle 66, when it is inserted into the store receptacle 80, is completely enclosed partially by the wall faces 88 and 90 and partially by the holding bands 104 with their two band portions 106 and 108. The closure element 110 makes it possible to tension the two band portions 106 and 108 relative to one another in order to thus fix the CO₂ store 64 securely to the cleaning appliance 10.

In the embodiment of FIGS. 18 to 23, the two upper projections, which partially define the wall face 88, are each provided with a slit 112 extending from the free ends 100. In this way, two projections 114 and 116 projecting from the ends 100 are formed, over each of which a respective annular rubber band 118 is stretched. In particular, hoses or cables of the cleaning appliance 10 can be placed into the two slits 112 and secured with the rubber bands 118.

In the two embodiments depicted in the Figures, the chassis 20 comprises in each case at least three wheels 120, 122, namely two wheels 120 in the form of main axis wheels 124 and two wheels 122 in the form of two steerable wheels 126. The steerable wheels 126 are arranged under the chassis frame 26, namely near the front side 74 of the cleaning appliance 10.

The steerable wheels 126 are configured in the form of steering rollers 128. The steering rollers 128 are each rotatable about a roller axis 130, which, during the intended use of the cleaning appliance 10, extends transversely, namely perpendicularly, to the direction of gravity 28. Furthermore, the steering rollers 128 can each be rotated about a steering axis 132, which extends in parallel or substantially in parallel to the direction of gravity 28.

The embodiments of the cleaning appliances 10 depicted in the Figures further comprise two fixing devices 134, which cooperate with the steering rollers 128 and are configured in the form of commercially available roller brakes 136. By pivoting same about an axis parallel to the respective roller axis 130, the steering rollers 128 can thus be blocked, namely with respect to a rotation about their respective roller longitudinal axis 130. When the fixing device 130 is actuated, the cleaning appliance 10 can no longer be moved. It is secured against rolling away.

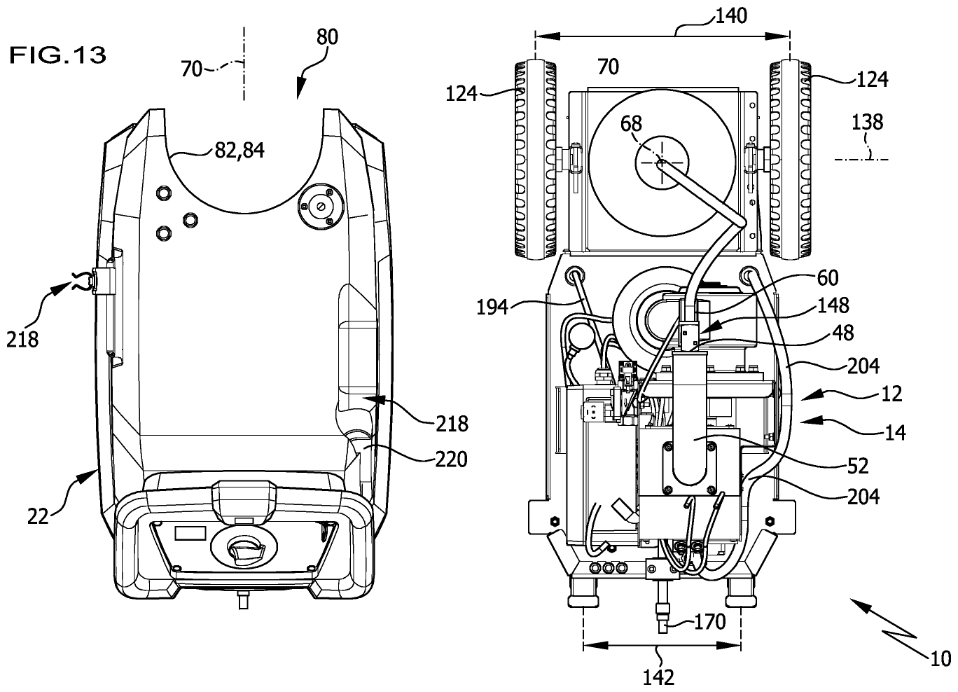

The two main axis wheels 124 of the chassis 20 are arranged so as to be rotatable about a common main axis 138. The main axis 138 extends somewhat above the support plate 94, which forms part of the chassis frame 26. As can be seen particularly well in FIG. 13, the store holding device 78 is arranged or formed in such a way that the CO₂ store 64 is positioned over the main axis 138. The CO₂ bottle 66 is optimally positioned on the cleaning appliance 10 when its bottle longitudinal axis 68 intersects the main axis 138.

The two main axis wheels 124 are arranged or formed on mutually averted sides of the cleaning appliance 10, projecting laterally beyond the chassis frame 26. A track width 140 of the main axis wheels 124 is significantly greater than a track width 142 of the steerable wheels 126. The track width 142 is schematically shown in FIG. 13. It defines a distance of midplanes of the two steering rollers 128 when they are oriented with their roller axes 130 in parallel to the main axis 138. In the embodiments depicted in the Figures, the track width 140 is more than 50% greater than the track width 142.

The two main axis wheels 142 define a main axis wheel diameter 144. The steerable wheels 126 define a steering wheel diameter 146. In the embodiments of the cleaning appliances depicted in the Figures, the main axis wheel diameter 144 is greater than the steering wheel diameter 146, namely more than twice as great, namely about three times as great.

For producing CO₂ pellets, which are not depicted in the Figures, liquid CO₂ is drawn from the CO₂ store 64 and is conducted through the connecting conduit 62 to the CO₂ connection 60. The CO₂ connection 60 projects from the pre-compression device 16 in a direction transverse, namely perpendicular, relative to the direction of gravity 28. The CO₂ connection 60 thus projects to the rear in the direction of the inlet longitudinal axis 54, i.e. pointing in the direction toward the CO₂ store 64.

A switching device is 148 arranged or formed between the CO₂ connection 60 and the pre-compression device 16 for opening and closing the fluidic connection between the CO₂ connection 60 and the pre-compression chamber inlet 48 of the pre-compression device 16.

Arranged in the region of the pre-compression chamber inlet 48 is an expansion nozzle, which is not depicted in the Figures, through which the liquid CO₂ flows when the switching device 148 opens the fluidic connection between the CO₂ connection 60 and the pre-compression device 16. The switching device 148 is configured, e.g., in the form of a valve 150 that is actuatable by means of a magnetic drive.

Upon flowing into the pre-compression chamber 46, the pressurized CO₂ expands and hereby cools down and forms CO₂ snow, which settles on an inner wall face of the pre-compression chamber 46 if the expansion nozzle is appropriately oriented. In the embodiments depicted in the Figures, the expansion nozzle is configured in such a way that the CO₂ stream exiting it flows spirally into and through the pre-compression chamber 46 in order to achieve a high probability of the forming CO₂ snow striking against the inner wall face of the pre-compression chamber 46.

The CO₂ snow successively settling on the inner wall face of the pre-compression chamber 46 is hereby compressed somewhat so that pre-compressed CO₂ snow agglomerates on the inner wall face. However, the CO₂ stream into the pre-compression chamber serves not only to form CO₂ snow, but also the convey the formed CO₂ snow toward the pre-compression chamber outlet 50.

The pre-compression chamber outlet 50 is directly fluidically connected to an inlet of the main compressing device 18. The CO₂ snow falls, in particular, with the assistance of gravity, into the main compressing device 18, namely between two compressor gear sleeves, which are rotatable about compressor sleeve axes 154 and are provided with outer toothings and are arranged meshing with one another. The compressor gear sleeves are coupled to the transmission 44 in a driving manner and can thus be set into rotation by activating the drive device 36.

Between the teeth of the compressor gear sleeves, in each case perforations are formed at the tooth base in the compressor gear sleeve walls, through which the CO₂ snow supplied by the pre-compression chamber 46 is pressed in the manner of a die and travels into a compressor sleeve inner space.

Also not depicted in the Figures are scraping elements, which project from a free end pointing away from the transmission 46 into the compressor gear sleeves, namely into the inner space defined by them and scrape off CO₂ strands, such that CO₂ pellets of a defined length are formed.

The scraping elements are also configured and arranged in such a way that they convey the CO₂ pellets from the inner space of the compressor gear sleeves to the free ends thereof, such that the CO₂ pellets fall out of the compressor gear sleeves into a collection hopper, which is arranged between the main compressing device 18 and a pellet delivery device 156 of the cleaning appliance 10.

The pellet delivery device 156 is configured to deliver CO₂ pellets into a pressurized gas stream 158. The pellet delivery device 156 comprises a dosing device 160 for dosing a number of the CO₂ pellets or a CO₂ pellet volume before the delivery into the pressurized gas stream 158.

The dosing device 160 comprises a dosing disc 162, which rotates about an axis of rotation 164 extending in parallel to the direction of gravity 28. A further drive device 165 in the form of an electric motor 167 serves to drive the pellet delivery device 156, in particular to rotate the dosing disc 162. Said electric motor 167 is, similarly to the drive device 36, oriented vertically with its drive shaft. The drive device 165 is arranged below the dosing disc 162 and is positioned right of the main plane 70, when seen from the front, i.e. in the direction toward the front side 74 of the cleaning appliance 10.

The dosing disc 162 comprises a plurality of dosing receptacles in each of which a limited number of CO₂ pellets or a defined CO₂ pellet volume can be accommodated. A top side of the dosing disc 162 pointing counter to the direction of gravity is arranged under an outlet of the collection hopper, such that CO₂ pellets can successively fall out of said outlet into the dosing receptacles of the dosing disc 162.

Spatially offset therefrom, a gas passage is arranged on the dosing device 160, which downstream defines a dosing outlet 166 of the dosing device 160 that is fluidically connected to a blasting conduit connection 170 of the cleaning appliance 10 by way of a connecting conduit 168. The pellet delivery device 156 is therefore fluidically connected to the blasting conduit connection 170.

The connecting conduit 168 extends directly below the dosing device 160 in parallel to the direction of gravity 28 and then extends in an arc up to an end portion, which extends perpendicularly to the direction of gravity 28. The end portion ends at the blasting conduit connection 170. In the described manner, the blasting conduit connection 170 projects out of the housing 22 transversely, namely perpendicularly, to the direction of gravity 28.

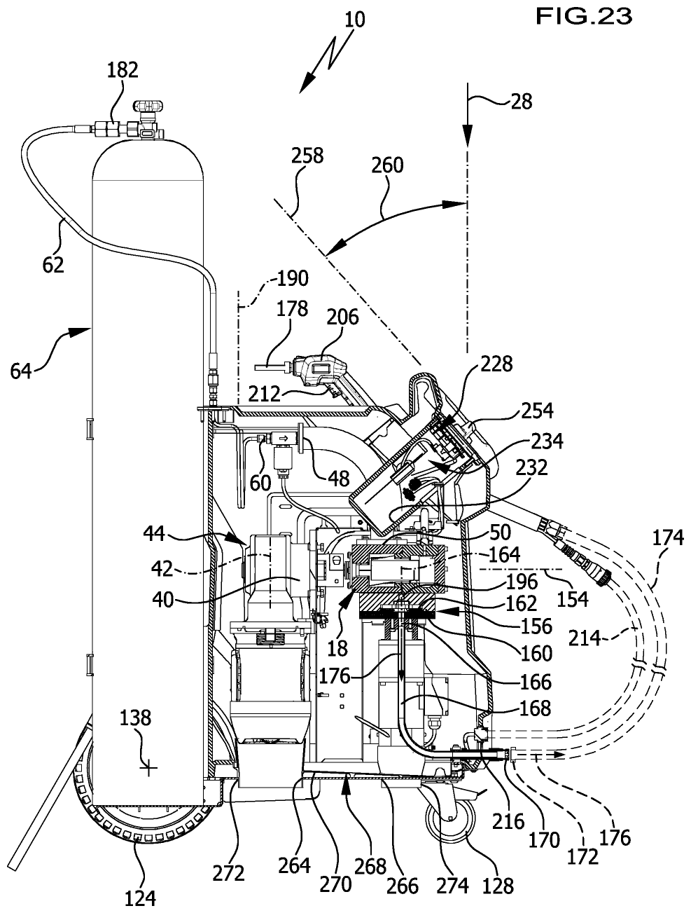

The blasting conduit connection 170 is configured to connect to a first free end 172 of a mixed jet conduit 174, which is drawn schematically with dashed lines in FIG. 23, with which a mixed stream 176 that is formed by the pressurized gas stream 148 and CO₂ pellets delivered thereto by the dosing device 160 is conducted to a blasting nozzle 178. The mixed stream 176 exits the blasting nozzle 178 and forms a mixed jet 208 that can be directed at a surface to be treated.

In the embodiments depicted in the Figures, the blasting conduit connection 170 is arranged or formed higher than the main axis 138 relative to the direction of gravity 28. Furthermore, the blasting conduit connection 170 and the main axis 138 extend transversely, namely perpendicularly, to one another. Furthermore, the blasting conduit connection 170 extends in parallel to the main plane 70. In the embodiments depicted in the Figures, the blasting conduit connection 170 is also configured symmetrically relative to the main plane 70.

Moreover, the blasting conduit connection 170, which extends away from the front side 74 of the cleaning appliance 10, and the CO₂ connection 60, which extends to the rear in the direction toward the CO₂ store 64, point in opposite directions.

In the embodiment of the cleaning appliance 10 of FIGS. 1 to 17, the connecting conduit 62 connects the CO₂ connection 60 directly to the CO₂ store 64. The connecting conduit 62 is configured in the form of a metal corrugated hose.

In the embodiment of the cleaning appliance 10 in accordance with FIGS. 18 to 23, a CO₂ housing connection 180 is additionally provided on the cleaning appliance 10. It projects from the top side 86 of the housing 22 and is fluidically connected to the CO₂ store 64, namely a bottle connection 182 thereof, by way of the connecting conduit 62, here too configured in the form of a metal corrugated hose.

The CO₂ housing connection 180 is oriented in parallel to the direction of gravity 28. In the embodiment of FIGS. 18 to 23, the CO₂ housing connection 180 points counter to the direction of gravity 28.

The CO₂ housing connection 180 and the CO₂ connection 60 are fluidically connected to one another by way of a CO₂ conduit 184. The CO₂ conduit 184 is configured in the form of a pipe 186, namely a metal pipe, and is therefore basically inflexible or substantially inflexible. Here, in order to enable a certain elasticity and a compensation of vibrations of the cleaning appliance 10 during operation thereof, the CO₂ conduit 184 is formed in such a way that it has at least one complete winding 188, also referred to as a closed winding 188. Thus, the CO₂ conduit 184, similarly to a spring element wound in a spiral shape, can, to a certain extent, compensate for vibrations between the CO₂ connection 60 and the CO₂ housing connection 180 during the operation of the cleaning appliance 10. The provided winding 188 thus provides the CO₂ conduit 184 a certain flexibility.

The winding 188 defines a winding plane 190. In the embodiment of a cleaning appliance schematically depicted in FIGS. 18 to 23, the winding plane 190 extends transversely, namely perpendicularly, to the main plane 70 and in parallel to the direction of gravity 28.

Furthermore, provided on the cleaning appliance 10 is a pressurized gas connection 192, which is configured to connect to a pressurized gas source that is not depicted in the Figures. Here, for example, it may be a compressor or a pressurized gas connection of a pressurized air network, as is used, e.g., in workshops or factories.

The pressurized gas connection 192 is fluidically connected to the pellet delivery device 126. A pressurized gas conduit 194 that connects the pressurized gas connection 192, which is arranged pointing to the rear from the cleaning appliance 10 and adjacent to the support plate 94, to a pressurized gas inlet 196 of the pellet delivery device 156 serves this purpose. Therefore, the pressurized gas connection 192 is arranged or formed in the region of the store holding device 78.

The pressurized gas stream 158 is conducted through the compressed gas conduit 194 from the pressurized gas source to the pellet delivery device 156 and to the blasting conduit connection 170.

A switching device 198 is arranged or formed between the pressurized gas connection 192 and the pellet delivery device 156 in order to selectively open and close the fluidic connection produced by the pressurized gas conduit 194 between the pressurized gas connection 192 and the pellet delivery device 156. The switching device 198, also referred to as a pneumatic switching device 198 in the present case, comprises a pressurized gas valve 200. It is of electromagnetically actuatable configuration.

The cleaning appliance 10 further comprises a CO₂ exhaust gas outlet 202. It serves to discharge CO₂ gas, which arises in the compressing device 14 in the form of non-solidified CO₂ gas or is created by sublimation of CO₂ pellets.

The CO₂ exhaust gas outlet 202 is fluidically connected to the pellet delivery device 156 and to a pellet outlet of the compressing device 14, namely by means of an exhaust gas conduit 204.

The CO₂ exhaust gas outlet 202 is arranged or formed in the region of the store holding device 78. It points in a direction opposite to the blasting conduit connection 170, thus to the rear away from the cleaning appliance 10. The CO₂ exhaust gas outlet 202 and the pressurized gas connection 192 are arranged or formed on both sides of the CO₂ store 64 between the CO₂ store 64 and one of the main axis wheels 124. In one embodiment, the CO₂ exhaust gas outlet 202 and the pressurized gas connection 192 are arranged or formed symmetrically relative to the main plane 70.

The aforementioned blasting nozzle 178 of the cleaning appliance 10 is configured as part of a blasting gun 206. The mixed stream 176 is discharged from the nozzle 178 as a mixed jet 208, which is formed by the pressurized gas serving as carrier gas and CO₂ pellets carried by said pressurized gas.

The blasting gun 206 comprises an actuating element 210 in the form of a trigger lever 212, with which a user can activate or deactivate the switching device 198 in order to selectively open and close the fluidic connection established by the pressurized gas conduit 194 between the pressurized gas connection 192 and the pellet delivery device 156. In this way, the mixed jet 208 can be discharged or interrupted using the blasting gun 206. The switching device 198 is actuated by an operator pivoting the trigger lever 212. The interruption of the mixed stream 176 is thus achieved not by closing a valve on the blasting gun 206, but rather by closing the switching device 198. The blasting gun 206 comprises an open blasting pipe, which leads to the blasting nozzle 178.

The actuating element 210 is control-operatively connected to an electrical control connection 216 of the cleaning appliance 10 by means of a control connecting line 214.

The control connection 216 is arranged or formed projecting to the front from the cleaning appliance 10 in parallel to the blasting conduit connection 170.

The control connection 216 is further arranged or formed on the housing 220 and remains thereon when the housing 22 is removed from the chassis 20, for example for maintenance or repair purposes. In the embodiments depicted in the Figures, the control connection 216 projects from the housing 22 transversely, namely perpendicularly, to the direction of gravity 28.

Furthermore, the control connection 216 is arranged or formed over or above the blasting conduit connection 170 relative to the direction of gravity 28.

The cleaning appliance 10 further comprises a blasting nozzle holding device 218 for holding the blasting nozzle 178 or the blasting gun 206 in a storage position. The blasting nozzle holding device 218 is integrated into the housing 22 in the two embodiments depicted in the Figures. In the embodiment of FIGS. 1 to 17, a gun receptacle 220 that is accessible from the front and the top is formed. In the embodiment of FIGS. 18 to 23, a C-shaped, laterally projecting gun receptacle 220 for the blasting gun 206 is molded onto the housing 22, in which the blasting gun 206 can be hung when it is not needed.

The housings 22 in the embodiments depicted in the Figures are made of a plastic material. For the production thereof, a rotational molding process is used, due to their size and complexity.

So that an operator can move the cleaning appliance 10 in a simple manner, it comprises a handlebar 222. It is arranged or formed immovably on the housing in the form of a substantially C-shaped bead 224 that is open at the front bottom. An operator can thus engage on each of the lateral handlebar portions 226 of the bead 224 that extend in parallel to one another with one hand, and thus the cleaning appliance 10 can be comfortably pushed and can also be turned and moved in any direction due to the steerable wheels 126 that are provided.

The cleaning appliance 10 further comprises a control and/or regulating device 228 for controlling and/or regulating the cleaning appliance 10. In particular, it serves to control and/or regulate the compressing device 14. The control and/or regulating device 228 is arranged in the housing inner space 24.

The control and/or regulating device 228 comprises, in particular, components that are under high voltage, in particular mains voltage. These are arranged in a separate control box 230 below the compressing device 14 relative to the direction of gravity 28. In particular, contactors for the drive device 36 are arranged in the control box 230. The control box 230 is connected to the current supply connection 32.

Formed on the housing commencing from the top front is a control receptacle 232, in which low-voltage components of the control and/or regulating device 228, in particular the electronic control circuit 234 of the cleaning appliance 10, are accommodated. The control circuit 234 is arranged above the compressing device 14.

The control receptacle 232 has an opening 236 that points forwards and upwards and that is closed with a closure plate 238. The closure plate 238 is removable and forms part of an input device 240 of the cleaning appliance 10. The input device 240 is arranged or formed on the housing 22 in the described manner. In particular, it is releasably connectable to the housing 22 in order to unblock the control receptacle 232 for gaining access to the control circuit 234 for maintenance and repair purposes.

Two control lines 242 and 244 have respective plug connectors 246 and 248 on free ends, which are able to be brought into force-locking and/or positive-locking engagement with respective plug couplings 250 and 252 arranged on the control circuit 234, in order to establish a control-operative connection between the control circuit 234 on the one hand and electrical components of the cleaning appliance 10, in particular the high-voltage components in the control box 230, on the other hand.

In order to facilitate maintenance work on the cleaning appliance 10, the plug connectors 246 and 248 that are in engagement with one another during operation can be separated from the corresponding plug couplings 250 and 252 in order to be able to completely remove the housing 22 from the chassis 20. For this separation, in particular, the removal of the closure plate 238 from the housing 22 is necessary.

The input device 240 comprises an operating mode selector switch 254, which serves for selecting an operating mode of the cleaning appliance 10. In the embodiment depicted in the FIGS. 18 to 23, the operating mode selector switch 254 serves to specify a desired pellet amount in the mixed stream 176 and thus also in the mixed jet 208, namely “low”, “medium”, or “high”, by bringing the operating mode selector switch 254 into the corresponding position. The desired pellet amount is indicated by corresponding symbols next to the operating mode selector switch 254.

Optionally, the input device 240 comprises a display device 256 for displaying an operating mode and/or operating parameters and/or error messages of the cleaning appliance 10.

In one embodiment, the display device 256 comprises a plurality of display elements 278 and 280. The display element 278 is configured in the form of an LCD display, which displays, in particular, an operating pressure in the pressurized gas conduit, operating hours, blasting times, and the like. Arranged next to the LCD display are symbols of the operating parameters that are displayed by the LCD display. In this way, an operator can directly associate the value displayed on the LCD display with the respective operating parameter.

The display element 280 comprises a plurality of fields, each with either a status symbol or an error symbol. These correspond to an operating status or an error status of the cleaning appliance 10. The plurality of fields are each associated with one or more light-emitting diodes for backlighting. If an error arises during operation of the cleaning appliance 10 that corresponds to one of the error symbols, the associated light-emitting diode is activated and thus displays to a user that an error has arisen and which error this is. The light-emitting diodes can be illuminated constantly or blink, depending on the error, such that a plurality of pieces of information are alternatively displayable. In an analogous manner, different operational states of the cleaning appliance 10 are displayed to the user with the display element.

In the embodiments depicted in the Figures, the handlebar 222 surrounds the input device 240. The bead 224 thus surrounds the opening 236.

For an optimal operation of the cleaning appliance 10, the input device 240 is arranged on the housing 22. The input device 240 defines a display plane 258, which is inclined relative to the direction of gravity 28. A display angle 260 enclosed between the display plane 258 and the direction of gravity 28 is in a range of about 30° to about 60°.

For an ergonomic and low-effort use of the cleaning appliance 10, the blasting conduit connection 170 is arranged or formed below the display device 240 relative to the direction of gravity 28. Due to the particular arrangement of the display device 240 in the region of the handlebar 222, a user always has a full overview of the functioning of the cleaning appliance 10, even when they are moving it. For this purpose, in the embodiments depicted in the Figures, it is advantageous for the input device 240 to be arranged above the steerable wheels 126 relative to the direction of gravity 28.

In order to be able to conduct actuating signals from the blasting gun 206 to the control and/or regulating device 228, the control connection 216 is control-operatively connected to the control and/or regulating device 228.

The control and/or regulating device 228 serves, in particular, to control the compressing device 14 in such a way that mechanical properties of the CO₂ pellets produced by it can be specified. In particular, the mechanical properties can be specified by a user with the input device 240, for example density, size, or number of CO₂ pellets to be produced per unit of time. This input can set by a user in a simple manner by correspondingly rotating the operating mode selector switch 254, which is configured as a rotary switch and for each operating mode of the cleaning appliance defines a switch position, into one of a plurality of switch positions. In one position of the operating mode selector switch 254, the cleaning appliance is completely switched off. This switch position is reached by rotating the operating mode selector switch 254 counter-clockwise up to a stop. For activating the cleaning appliance 10, the operating mode selector switch 254 must be rotated clockwise into one of the possible switch positions.

Optionally, a shelf 262 may be formed on the cleaning appliance 10 on the top side 86 of the housing 22, as is depicted by way of example with the embodiment in in FIGS. 18 to 23. The shelf 262 is configured in the form of a flat depression in which, for example, accessories of the cleaning appliance 10 can be stored during use.

In the embodiment of the cleaning appliance 10 in accordance with FIGS. 18 to 23, the chassis frame has perforations 264 and 266. The perforations 264 and 266 are arranged directly below the drive devices 36 and 165, respectively, and serve to supply fresh air to same in order to prevent an overheating during the operation of the cleaning appliance 10.

The cleaning appliance 10 further comprises a condensation tray 268 in order to collect condensation and melt water. The condensation tray 268 is arranged on the chassis frame 26 and comprises a tray base 270, which is inclined somewhat in the direction toward the front side 74. In the region of the perforations 264 and 266, the condensation tray 268 is also perforated. In these regions, it comprises two sleeve-shaped air guidance elements 272 and 274, which are also referred to as air scoops. The air guidance elements 272 and 274 enclose respective lower end regions of the drive devices 36 and 165 and extend through the perforations 264 and 266. Furthermore, the air guidance elements 272 and 274 are formed in one piece with the condensation tray 268 in order to prevent condensation and melt water from being able to leak out through the perforations 264 and 266. A drainage opening formed on the condensation tray 268 near the front side 74, which during the operation of the cleaning appliance is closed by a closure plug 276, serves for draining condensation and melt water collected in the condensation tray 268. For explanation purposes, it should be noted that the components in contact with CO₂, in particular all components of the compressing device 14, cool down to a large extent during the operation of the cleaning appliance 10, namely significantly below 0° C. Water in the ambient air condenses on cold surfaces of the components and freezes solid, thus forming significant ice deposits. After completion of the operation of the cleaning appliance 10, the deposited ice thaws and the melt water collects in the condensation tray 268. The cleaning appliance 10 can then, for example, be pushed over a drain in the floor, which is not depicted in the Figures, and the closure plug can be removed in order to let the condensation tray 268 drain in a defined manner.

The described embodiments of cleaning appliances 10 enable a user to treat surfaces to be treated, for example surfaces that must be cleaned of layers of grease and lubricants, with a mixed jet 208. Compared to conventional cleaning appliances that produce a mixed jet of a pressurized gas and CO₂ pellets, the described cleaning appliances 10 have the advantage that the CO₂ pellets are always available in the desired amount and quality when using the cleaning appliance 10, because they are produced directly with the cleaning appliance 10. Merely an appropriately filled CO₂ store 64 must be provided, for example a CO₂ bottle 66 containing liquid CO₂.

By means of the compressing device 14, CO₂ pellets are produced according to a request of the user following an actuation of the actuating element 210. In particular, by actuating the trigger lever 212, the compressing device 14 can be activated for forming CO₂ pellets.

CO₂ bottles 66 with liquid CO₂ can be easily stored and stocked. No separate cooling is required for this purpose, but which is required if a cleaning appliance does not produce CO₂ pellets itself but rather must be filled with industrially produced CO₂ pellets. For CO₂ pellets of that kind, which, in particular, must be purchased, a significant stocking expenditure is required, because the CO₂ pellets have to be stored at very low temperatures so as to not sublimate. Even then, it cannot be avoided that the CO₂ pellets partially or completely sublimate. It is different with the described cleaning appliances 10. Here, the CO₂ pellets are introduced into the pressurized gas stream 158 by means of the pellet delivery device 156 to form the mixed stream 176, directly after said CO₂ pellets are compressed by the main compressing device 18, the mixed stream 176 being able to be conducted to the blasting nozzle 178 and exit same as a mixed jet 208.

The described cleaning appliances 10 are compact, easy to handle, and can be easily moved and are safe. In particular, they can be used even in the case of high outer temperatures, in particular at ambient temperatures of up to 40° C. Because the pressure in the CO₂ store 64 increases at higher ambient temperatures, so does the gas content. Therefore, at ambient temperatures of more than 40° C., the efficiency of the conversion from liquid CO₂ into CO₂ snow can decrease. This effect can also arise already beginning at about 31° C., because here the CO₂ falls into the supercritical state. When the CO₂ store 64 cools back down, the efficiency of the described snow production increases again.

Particularly in the case of high outer temperatures, the direct production of CO₂ pellets in the cleaning appliance 10 itself is of great advantage, because it is possible to be able to provide CO₂ pellets at all with high reliability for cleaning purposes.

### REFERENCE NUMERAL LIST

10 cleaning appliance
12 apparatus
14 compressing device
16 pre-compression device
18 main compressing device
20 chassis
22 housing
24 housing inner space
26 chassis frame
28 direction of gravity
30 energy supply connection
32 current supply connection
34 connection plug
36 drive device
38 electric motor
40 housing cap
42 drive shaft axis
44 transmission
46 pre-compression chamber
48 pre-compression chamber inlet
50 pre-compression chamber outlet
52 pipe
54 inlet longitudinal axis
56 outlet longitudinal axis
58 angle of curvature
60 CO₂ connection
62 connecting conduit
64 CO₂ store
66 CO₂ bottle
68 bottle longitudinal axis
70 main plane
72 rear side
74 front side
76 symmetry plane
78 store holding device
80 store receptacle
82 upper recess
84 lower recess
86 top side
88 wall face
90 wall face
92 wall face
94 support plate
96 standing surface
98 securing element
100 end
102 end
104 holding band
106 band portion
108 band portion
110 closure element
112 slit
114 projection
116 projection
118 rubber band
120 wheel
122 wheel
124 main axis wheel
126 steerable wheel
128 steering roller
130 roller axis
132 steering axis
134 fixing device
136 roller brake
138 main axis
140 track width
142 track width
144 main axis wheel diameter
146 steering wheel diameter
148 switching device
150 valve
152 magnetic drive
154 compressor sleeve axis
156 pellet delivery device
158 compressed gas stream
160 dosing device
162 dosing disc
164 rotational axis
165 drive device
166 dosing outlet
167 electric motor
168 connecting conduit
170 blasting conduit connection
172 first free end
174 mixed jet conduit
176 mixed stream
178 blasting nozzle
180 CO₂ housing connection
182 bottle connection
184 CO₂ conduit
186 pipe
188 winding
190 winding plane
192 pressurized gas connection
194 pressurized gas conduit
196 pressurized gas inlet
198 switching device
200 pressurized gas valve
202 CO₂ exhaust gas outlet
204 exhaust gas conduit
206 blasting gun
208 mixed jet
210 actuating element
212 trigger lever
214 control connecting line
216 control connection
218 blasting nozzle holding device
220 gun receptacle
222 handlebar
224 bead
226 handlebar portion
228 control and/or regulating device
230 control box
232 control receptacle
234 control circuit
236 opening
238 closure plate
240 input device
242 control line
244 control line
246 plug connector
248 plug connector
250 plug coupling
252 plug coupling
254 operating mode selector switch
256 display device
258 display plane
260 display angle
262 shelf
264 perforation
266 perforation
268 condensation tray
270 tray base
272 air guidance element
274 air guidance element
276 closure plug
278 display element
280 display element

What is claimed is:

1. A cleaning appliance for blasting surfaces to be treated with a mixed stream of a pressurized gas and CO₂ pellets, comprising an apparatus for producing CO₂ pellets from liquid or gaseous CO₂, wherein the apparatus comprises a compressing device for compressing CO₂ snow to form the CO₂ pellets, wherein the cleaning appliance comprises a drive device with a drive shaft for driving the compressing device, and wherein, during the intended use of the cleaning appliance, the drive shaft extends in parallel or substantially in parallel to the direction of gravity.

2. The cleaning appliance in accordance with claim 1, wherein at least one of
a) the drive device comprises an electric motor
and
b) the cleaning appliance comprises a transmission coupled to the drive device and wherein the transmission is coupled to the compressing device in a driving manner.

3. The cleaning appliance in accordance with claim 1 or a cleaning appliance for blasting surfaces to be treated with a mixed stream of a pressurized gas and CO₂ pellets, comprising an apparatus for producing CO₂ pellets from liquid or gaseous CO₂, wherein the cleaning appliance defines a main plane, wherein the main plane extends in parallel to the direction of gravity and reaches from a rear side to a front side of the cleaning appliance, wherein the main plane defines a symmetry plane or substantially defines a symmetry plane of the cleaning appliance,
wherein, in particular, the drive shaft extends in the main plane.

4. The cleaning appliance in accordance with claim 1 or a cleaning appliance for blasting surfaces to be treated with a mixed stream of a pressurized gas and CO₂ pellets, comprising an apparatus for producing CO₂ pellets from liquid or gaseous CO₂, wherein the compressing device comprises a pre-compression device and a main compressing device,
wherein, in particular, at least one of
a) the pre-compression device is configured to pre-compress CO₂ snow produced by expansion of liquid or pressurized CO₂, wherein, in particular, the pre-compression device is configured in the form of a fluid mechanical pre-compression device,
and
b) the pre-compression device extends in parallel or substantially in parallel to the main plane.

5. The cleaning appliance in accordance with claim 1 or a cleaning appliance for blasting surfaces to be treated with a mixed stream of a pressurized gas and CO₂ pellets, comprising an apparatus for producing CO₂ pellets from liquid or gaseous CO₂, wherein the cleaning appliance comprises a CO₂ store.

6. The cleaning appliance in accordance with claim 5, wherein the CO₂ store at least one of
a) contains liquid CO₂ or pressurized gaseous CO₂
and
b) is configured in the form of a CO₂ bottle, wherein the CO₂ bottle defines a bottle longitudinal axis, and wherein the bottle longitudinal axis extends in parallel or substantially in parallel to the direction of gravity,
wherein, in particular, the bottle longitudinal axis extends in the main plane or near the main plane,
and
c) is arranged symmetrically relative to the main plane
and
d) is fluidically connected to the compressing device, in particular to the pre-compression device.

7. The cleaning appliance in accordance with claim 5, wherein the cleaning appliance comprises a store holding device for the CO₂ store,
wherein, in particular, the store holding device at least one of
a) defines a store receptacle for the CO₂ store, wherein, in particular, the store receptacle is configured symmetrically relative to the main plane,
and
b) comprises at least one securing element for the CO₂ store, wherein, in particular, the at least one securing element is configured in the form of a holding bracket or in the form of a holding band.

8. The cleaning appliance in accordance with claim 1 or a cleaning appliance for blasting surfaces to be treated with a mixed stream of a pressurized gas and CO₂ pellets, comprising an apparatus for producing CO₂ pellets from liquid or gaseous CO₂, wherein the cleaning appliance is of mobile configuration and comprises a chassis,
wherein, in particular, the chassis comprises at least three wheels and wherein at least one of the three wheels is of steerable configuration, in particular in the form of a steering roller, further in particular in the form of a steering roller with a fixing device.

9. The cleaning appliance in accordance with claim 8, wherein the chassis defines a main axis and wherein two wheels of the chassis are configured in the form of two main axis wheels that are arranged or formed so as to be rotatable about the main axis,
wherein, in particular, at least one of
a) the main axis wheels define a main axis wheel diameter, wherein the at least one wheel of steerable configuration defines a steering wheel diameter, and wherein the main axis wheel diameter is greater than the steering wheel diameter, in particular at least about twice as great, further in particular about three times as great,
and
b) the store holding device is arranged or formed in such a way that the CO₂ store is positioned over the main axis
and
c) the bottle longitudinal axis intersects the main axis.

10. The cleaning appliance in accordance with claim 1 or a cleaning appliance for blasting surfaces to be treated with a mixed stream of a pressurized gas and CO₂ pellets, comprising an apparatus for producing CO₂ pellets from liquid or gaseous CO₂, wherein the cleaning appliance comprises a blasting conduit connection for connecting to a first free end of a mixed jet conduit and wherein the blasting conduit connection is arranged or formed projecting transversely, in particular perpendicularly, to the direction of gravity.

11. The cleaning appliance in accordance with claim 10, wherein the blasting conduit connection at least one of
a) is arranged or formed higher than the main axis relative to the direction of gravity
and
b) and the main axis extend transversely, in particular perpendicularly, to one another
and
c) extends in parallel to the main plane, wherein, in particular, the blasting conduit connection is configured symmetrically relative to the main plane,
and
d) and the CO₂ connection are arranged or formed pointing in linearly independent directions, in particular pointing in opposite directions.

12. The cleaning appliance in accordance with claim 1 or a cleaning appliance for blasting surfaces to be treated with a mixed stream of a pressurized gas and CO₂ pellets, comprising an apparatus for producing CO₂ pellets from liquid or gaseous CO₂, wherein the cleaning appliance comprises a housing, wherein the housing defines a housing inner space, and wherein the compressing device is arranged or formed at least partially, in particular completely, in the housing inner space.

13. The cleaning appliance in accordance with claim 12, wherein at least one of
a) the chassis, in particular the chassis frame, closes or substantially closes the housing from the bottom relative to the direction of gravity
and
b) the store holding device is molded onto the housing at least in sections
and
c) the housing is made of a plastic material, in particular by injection molding or in a rotational molding process,
and
d) the housing comprises a handlebar for holding and pushing of the cleaning appliance, wherein, in particular, the handlebar is arranged or formed immovably on the housing,
and
e) the cleaning appliance has a CO₂ housing connection and wherein the CO₂ housing connection is arranged or formed projecting from the housing on the outside.

14. The cleaning appliance in accordance with claim 1 or a cleaning appliance for blasting surfaces to be treated with a mixed stream of a pressurized gas and CO₂ pellets, comprising an apparatus for producing CO₂ pellets from liquid or gaseous CO₂, wherein the cleaning appliance comprises a pressurized gas connection for connecting to a pressurized gas source.

15. The cleaning appliance in accordance with claim 14, wherein the cleaning appliance comprises a pellet delivery device for delivering CO₂ pellets into a pressurized gas stream and wherein the pressurized gas connection is fluidically connected to the pellet delivery device,
wherein, in particular, the pellet delivery device at least one of
a) is fluidically connected to the blasting conduit connection
and
b) comprises a dosing device for dosing a number of CO₂ pellets and/or a CO₂ pellet volume before the delivery into the pressurized gas stream.

16. The cleaning appliance in accordance with claim 1 or a cleaning appliance for blasting surfaces to be treated with a mixed stream of a pressurized gas and CO₂ pellets, comprising an apparatus for producing CO₂ pellets from liquid or gaseous CO₂, wherein the cleaning appliance comprises a control and/or regulating device for controlling and/or regulating the cleaning appliance, in particular the compressing device.

17. The cleaning appliance in accordance with claim 16, wherein the control and/or regulating device at least one of
a) is arranged or formed in the housing
and
b) is arranged or formed at least partially below the compressing device and at least partially above the compressing device relative to the direction of gravity
and
c) is configured to control the compressing device in such a way that mechanical properties of the CO₂ pellets to be produced are specifiable
and
d) comprises an input device for specifying the mechanical properties, in particular density and/or size, and/or a number of CO₂ pellets to be produced,
wherein, in particular, the input device is configured to be releasably connectable to the housing.

18. The cleaning appliance in accordance with claim 1 or a cleaning appliance for blasting surfaces to be treated with a mixed stream of a pressurized gas and CO₂ pellets, comprising an apparatus for producing CO₂ pellets from liquid or gaseous CO₂, wherein the cleaning appliance comprises an energy supply connection, in particular a current supply connection, for connecting the cleaning appliance to an energy supply network, in particular to a current supply network.

19. The cleaning appliance in accordance with claim 1 or a cleaning appliance for blasting surfaces to be treated with a mixed stream of a pressurized gas and CO₂ pellets, comprising an apparatus for producing CO₂ pellets from liquid or gaseous CO₂, wherein the cleaning appliance comprises a CO₂ exhaust gas outlet for discharging CO₂ gas that did not solidify in the compressing device or that was formed due to sublimation of CO₂ pellets.

20. The cleaning appliance in accordance with claim 19, wherein the CO₂ exhaust gas outlet at least one of
a) is fluidically connected to the pellet delivery device and a pellet outlet of the compressing device
and
b) is arranged or formed in the region of the store holding device, in particular pointing in the opposite or substantially in the opposite direction relative to the blasting conduit connection.

21. The cleaning appliance in accordance with claim 10, wherein the cleaning appliance comprises a blasting nozzle and a mixed jet conduit and wherein the mixed jet conduit connects the blasting conduit connection to the blasting nozzle,
wherein, in particular, the cleaning appliance comprises a blasting nozzle holding device for holding the blasting nozzle in a storage position,
wherein, further in particular, the blasting nozzle holding device is integrated into the housing or is molded onto the housing, wherein, in particular, the blasting nozzle device comprises a C-shaped receptacle for the blasting gun.
